(19) United States
(12) Patent Application Publication
(10) Pub. No.: US 2025/0343279 A1
(43) Pub. Date: Nov. 6, 2025

(54) SURFACE MODIFIED SOLID-STATE ELECTROLYTES, PROCESSES FOR THEIR PREPARATION, AND THEIR USE IN ELECTROCHEMICAL CELLS

(71) Applicants: HYDRO-QUÉBEC, Montréal (CA); BOARD OF REGENTS, THE UNIVERSITY OF TEXAS SYSTEM, Austin, TX (US)

(72) Inventors: Hadi KHANI, Austin, TX (US); Jiang CUI, San Jose, CA (US); Abdelbast GUERFI, Brossard (CA)

(21) Appl. No.: 18/867,079

(22) PCT Filed: Jul. 12, 2023
(86) PCT No.: PCT/CA2023/050934

§ 371 Date: Nov. 19, 2024

Related U.S. Application Data
(60) Provisional application No. 63/368,165, filed on Jul. 12, 2022.

(51) Int. Cl. H01M 10/42; H01M 10/0525; H01M 10/0562; H01M 10/058

(52) U.S. Cl. CPC H01M 10/4235; H01M 10/0525; H01M 10/0562; H01M 10/058; H01M 2300/0071; H01M 2300/0094

(57) ABSTRACT

The present technology relates to a process for producing a coated solid-state electrolyte comprising a metal-based coating layer deposited on at least a portion of a surface of a solid-state electrolyte, the process comprising the steps of: (i) depositing a precursor powder of a metal-based coating material on at least a portion of a surface of a solid-state electrolyte; (ii) subjecting the precursor powder of the metal-based coating material to a rapid heating method to produce a melted metal-based coating material; and (iii) solidifying the melted metal-based coating material to produce the coated solid-state electrolyte. Also described are coated solid-state electrolytes obtained by said process as well as electrochemical cells and batteries comprising said coated solid-state electrolytes. For instance, the battery can be a lithium battery or a lithium-ion battery.

### RELATED APPLICATION

This application claims priority under applicable laws to U.S. provisional application No. 63/368,165 filed on Jul. 12, 2022, the content of which is incorporated herein by reference in its entirety for all purposes.

### TECHNICAL FIELD

The present application relates to the field of solid-state electrolytes and their use in electrochemical applications. More particularly, the present application relates to solid-state electrolytes having at least one modified surface, to their manufacturing processes and to their uses in electrochemical cells and in batteries, and, particularly, in all-solid-state batteries.

### BACKGROUND

The ever-increasing demand for renewable energies calls for the development of high-performance energy storage devices. Lithium-ion batteries (LIBs) are the major energy storage devices in portable electronic devices and have dominated the electric vehicle market. However, the current LIBs with a liquid electrolyte and a graphite negative electrode have reached their theoretical energy density limitation (Choi, Jang Wook, and Doron Aurbach. “Promise and reality of post-lithium-ion batteries with high energy densities.” Nature Reviews Materials 1, no. 4 (2016): 1-16). One of the most promising strategies to further improve the energy density of LIBs is to replace the graphite negative electrode with lithium metal, the latter of which is widely regarded as the “holy grail” of battery research and can increase the capacity of the negative electrode by ten times due to the hostless lithium storage mechanism of the lithium metal negative electrode.

The key challenge lithium metal negative electrodes are currently facing is its unstable interface with a liquid electrolyte, which causes the dendritic lithium growth and eventually short circuit of the battery (Lin, Dingchang, et al. “Reviving the lithium metal anode for high-energy batteries.” Nature nanotechnology 12, no. 3 (2017): 194-206). It is widely accepted that using a solid-state electrolyte is one of the most promising solutions to suppress a dendrite growth thanks to its higher mechanical strength as compared to the traditional liquid electrolyte. An all-solid-state lithium metal battery (ASSLMB) with a solid-state electrolyte and a lithium metal negative electrode can potentially have a much higher energy as compared to the traditional LIBs (Tikekar, Mukul D., et al. “Design principles for electrolytes and interfaces for stable lithium-metal batteries.” Nature Energy 1, no. 9 (2016): 1-7).

However, the interface between the solid-state electrolyte and the lithium metal negative electrode is vastly different from the counterpart consisting of the liquid electrolyte (Liu, Bin, et al. “Advancing lithium metal batteries.” Joule 2.5 (2018): 833-845). For example, many solid electrolytes including sulfide-based electrolytes (Lau, Jonathan, et al. “Sulfide solid-state electrolytes for lithium battery applications.” Advanced Energy Materials 8.27 (2018): 1800933), argyrodite-based electrolytes (Yu, Chuang, et al. “Recent development of lithium argyrodite solid-state electrolytes for solid-state batteries: synthesis, structure, stability and dynamics.” Nano Energy 83 (2021): 105858), and halide-based electrolytes (Li, Xiaona, et al. “Progress and perspectives on halide lithium conductors for all-solid-state lithium batteries.” Energy & Environmental Science 13.5 (2020): 1429-1461) are revealed to be electrochemically unstable against the reduction of lithium. A solid electrolyte interphase (SEI) layer will form upon contact between the solid electrolyte and the lithium metal negative electrode, resulting in an elevated interfacial resistance and increased possibility of dendrite formation. Among all solid electrolytes, garnet-type solid electrolytes have a wide electrochemical stability window and are among the few that are stable at the electrochemical potential of the lithium metal, making them an excellent candidate to be used in ASSLMB (Thangadurai, Venkataraman et al. “Garnet-type solid-state fast Li ion conductors for Li batteries: critical review.” Chemical Society Reviews 43.13 (2014): 4714-4727).

Despite the theoretical stability of garnet-type electrolytes paired with lithium metal negative electrodes, the interfacial contact between these two components is extremely poor in practice owing to the Li₂CO₃ surface contamination and intrinsic lithiophobic properties of garnet-type electrolytes. It is widely reported that the interfacial resistance can reach above 1000 Ωcm⁻² when a garnet-type solid-state electrolyte is coupled with a lithium metal negative electrode (Wang, Chengwei, et al. “Garnet-type solid-state electrolytes: materials, interfaces, and batteries.” Chemical reviews 120.10 (2020): 4257-4300; Zhao, Ning, et al. “Solid garnet batteries.” Joule 3.5 (2019): 1190-1199; and Krauskopf, Thorben, et al. “Lithium-metal growth kinetics on LLZO garnet-type solid-state electrolytes.” Joule 3.8 (2019): 2030-2049). The large interfacial resistance causes a severe voltage polarization during lithium plating/stripping cycles, resulting in the formation of dendritic lithium. Ultimately, the dendritic lithium penetrates through the grain boundaries of the electrolyte, causing an internal short circuit and the failure of the battery (Porz, Lukas, et al. “Mechanism of lithium metal penetration through inorganic solid-state electrolytes.” Advanced Energy Materials 7.20 (2017): 1701003; and Ning, Ziyang, et al. “Visualizing plating-induced cracking in lithium-anode solid-electrolyte cells.” Nature Materials 20.8 (2021): 1121-1129). To tackle the interfacial contact issue, various interfacial coating layers have been developed during the past several years, however, the complete elimination of such an interfacial resistance with a simple, cost-effective, and scalable technique has remained as a challenge. For instance, an interfacial coating layer consisting of germanium can reduce interfacial resistance to 115 Ωcm⁻² (Luo, W., et al. “Reducing Interfacial Resistance between Garnet-Structured Solid-State Electrolyte and Li-Metal Anode by a Germanium Layer.” Adv. Mater 29 (2017): 1606042). A chemical treatment method using ammonium fluoride removes the surface contamination and generate an LiF coating layer, giving rise to a reduced interfacial resistance of 38.7 Ωcm⁻² (Duan, Hui, et al. “Building an air stable and lithium deposition regulable garnet interface from moderate-temperature conversion chemistry.” Angewandte Chemie 132, no. 29 (2020): 12167-12173). An interfacial coating layer made of graphite has also shown to reduce the interfacial resistance to 105 Ωcm⁻² (Shao, Yuanjun, et al. “Drawing a soft interface: an effective interfacial modification strategy for garnet-type solid-state Li batteries.” ACS Energy Letters 3.6 (2018): 1212-1218).

A conversion reaction of the interlayer MoS₂ with lithium metal has revealed to facilitate the interfacial wetting and reduces the interfacial resistance of a garnet electrolyte with lithium to 14 Ωcm⁻² (Fu, Jiamin, et al. “In situ formation of a bifunctional interlayer enabled by a conversion reaction to initiatively prevent lithium dendrites in a garnet solid-state electrolyte.” Energy & Environmental Science 12.4 (2019): 1404-1412). To date, the best performing interfacial coating with an interfacial resistance of 1 Ωcm⁻² has been achieved with a thin Al₂O₃ layer deposited onto the surface of the garnet-type electrolytes by atomic layer deposition (Han, Xiaogang, et al. “Negating interfacial impedance in garnet-based solid-state Li metal batteries.” Nature materials 16.5 (2017): 572-579).

However, there is still a need for the development of new coating materials to protect the interface between a solid-state electrolyte and a negative electrode, particularly ones providing advantages over conventional coating materials.

### SUMMARY

According to one aspect, the present technology relates to a process for producing a coated solid-state electrolyte comprising a metal-based coating layer deposited on at least a portion of a surface of a solid-state electrolyte, the process comprising the steps of:
(i) depositing the precursor powder of a metal-based coating material on at least a portion of a surface of a solid-state electrolyte;
(ii) subjecting the precursor powder of the metal-based coating material to a rapid heating method to produce a melted metal-based coating material; and
(iii) solidifying the melted metal-based coating material to produce the coated solid-state electrolyte.

In one embodiment, step (i) is carried out by a mechanical or a chemical coating process. In an embodiment of interest, step (i) is carried out by a powder deposition technique. In a preferred embodiment, the powder deposition technique is a powder spreading technique, a powder rubbing technique, or a powder dipping technique.

In another embodiment, the process further comprises a step of removing an excess amount of the precursor powder of the metal-based coating material prior to step (ii).

In another embodiment, the rapid heating method is selected from a Joule heating method, a microwave radiation method, a spark plasma sintering method, an induction heating method, a laser sintering method, an infrared radiation method, and an electric pulse consolidation method. In an embodiment of interest, the rapid heating method is the Joule heating method.

In another embodiment, the rapid heating method is carried out for a period of less than about 90 s, or less than about 80 s, or less than about 70 s, or less than about 60 s, or less than about 50 s, or less than about 40 s, or less than about 30 s, or less than about 25 s, or less than about 20 s, or less than about 15 s, or less than about 10 s.

In another embodiment, the rapid heating method is carried out for a period in the range of from about 1 s to about 90 s, or from about 1 s to about 80 s, or from about 1 s to about 70 s, or from about 1 s to about 60 s, or from about 1 s to about 50 s, or from about 1 s to about 40 s, or about 1 s to about 30 s, or about 1 s to about 25 s, or from about 1 s to about 20 s, or from about 1 s to about 15 s, or from about 1 s to about 10 s, or from about 2 s to about 10 s, or from about 3 s to about 10 s.

In another embodiment, the rapid heating method is carried out at a temperature in the range of from about 550° C. to about 1400° C., or from about 600° C. to about 1350° C., or from about 650° C. to about 1300° C., or from about 700° C. to about 1250° C., or from about 700° C. to about 1200° C.

In another embodiment, the rapid heating method is carried out at a heating temperature ramp rate in the range of from about 5×10²° C. min⁻¹ to about 1.44×10⁴° C. min⁻¹. In an embodiment of interest, the rapid heating method is carried out at a heating temperature ramp rate of about 3×10³° C. min⁻¹.

In another embodiment, step (iii) is carried out at a cooling temperature ramp rate in the range of from about 5×10²° C. min⁻¹ to about 4.8×10³° C. min⁻¹. In an embodiment of interest, step (iii) is carried out at a cooling temperature ramp rate of about 3×10³° C. min⁻¹. In another embodiment, the process further comprises a step of preparing the solid-state electrolyte.

In another embodiment, the process further comprises a step of densifying the solid-state electrolyte. In an embodiment of interest, the densifying step is carried out by a rapid heating method. In a preferred embodiment, the rapid heating method is selected from a Joule heating method, a microwave radiation method, a spark plasma sintering method, an induction heating method, a laser sintering method, an infrared radiation method, and an electric pulse consolidation method. In a more preferred embodiment, the rapid heating method is the Joule heating method.

According to another aspect, the present technology relates to a coated solid-state electrolyte obtained by the process as defined herein.

In one embodiment, the metal-based coating layer is uniformly deposited on the surface of the solid-state electrolyte. In an alternative embodiment, the metal-based coating layer is heterogeneously dispersed on the surface of the solid-state electrolyte.

In another embodiment, the metal-based coating material is selected from the group consisting of a metallic element, a metal alloy, a metal oxide, a fluorinated metal, and a combination of at least two thereof.

In another embodiment, the metal-based coating material is a metallic element. In one embodiment of interest, the metallic element is selected from the group consisting of Al, Cu, Ag, Sn, Sb, and Bi. In a preferred embodiment, the metallic element is Cu, Ag, or Sn.

In another embodiment, the metal-based coating material is a metal alloy. For example, the metal alloy comprises a first metallic component selected from the metal elements of groups 14 and 15 of the periodic table of the elements and a second metallic component, wherein the second metallic component is different from the first metallic component. In an embodiment of interest, the first metallic component is selected from Sn, Sb, and Bi. In another embodiment of interest, the second metallic component is an alkali metal, an alkali earth metal, a transition metal, a post-transition metal, a metalloid, or a lanthanide. For example, the second metallic component is selected from the group consisting of Al, Mn, Co, Ni, Cu, Ag, Sn, Sb, La, Tb, and Bi. In a preferred embodiment, the metal alloy is a Sn—Mn, Sn—Co, Sn—Ni, Sn—Cu, Sn—Cu—Tb, Sn—Ag, Sn—La, Sn—Bi—Ag, Sb—Cu, Sb—Ag, or Bi—Ag-based alloy. In another preferred embodiment, the metal alloy is Cu₃Sn or Cu₆Sn₅. In another preferred embodiment, the metal alloy is AgSnₓBi₁₋ₓ, where x is 0≤x≤1. In a more preferred embodiment, the metal alloy is selected from the group consisting of AgSn, AgSn_{0.8}Bi_{0.2}, AgSn_{0.6}Bi_{0.4}, AgSn_{0.4}Bi_{0.6}, and AgBi.

In another embodiment, the metal-based coating material is a fluorinated metal. In an embodiment of interest, the fluorinated metal is selected from the group consisting of SnF₂, SnF₄, ZnF₂, InF₃, GaF₃, SbF₃, TiF, PbF₂, CuF₂, BiF₃, AlF₃, AgF, and LiF.

In another embodiment, the metal-based coating material is a metal oxide. In an embodiment of interest, the metal oxide is selected from the group consisting of SnO, SnO₂, CuO, Cu₂O, Bi₂O₃, Al₂O₃, and Ag₂O.

In another embodiment, the solid-state electrolyte is a ceramic solid-state electrolyte. In an embodiment of interest, the ceramic solid-state electrolyte is a garnet-type solid-state electrolyte. In a preferred embodiment, the garnet-type solid-state electrolyte is selected from the group consisting of Li₇La₃Zr₂O₁₂ (LLZO), Li_{6.25}Al_{0.25}La₃Zr₂O₁₂ (Al-LLZO), Li_{6.5}La₃Zr_{1.5}Ta_{0.5}O₁₂ (LLZTO), Li_{6.35}Al_{0.05}La₃Zr₂Ta_{0.5}O₁₂ (Al-LLZTO), Li_{6.25}Nd₃Zr_{1.5}Ta_{0.5}O₁₂ (LNZTO), Li_{6.25}Sm₃Zr_{1.5}Ta_{0.5}O₁₂ (LSZTO), and Li_{6.25}(Sm_{0.5}La_{0.5})₃Zr_{1.5}Ta_{0.5}O₁₂ (LSZTO). In a more preferred embodiment, the garnet-type solid-state electrolyte is selected from the group consisting of Li₇La₃Zr₂O₁₂ (LLZO), Li_{6.25}Al_{0.25}La₃Zr₂O₁₂ (Al-LLZO), Li_{6.5}La₃Zr_{1.5}Ta_{0.5}O₁₂ (LLZTO), and Li_{6.35}Al_{0.05}La₃Zr₂Ta_{0.5}O₁₂ (Al-LLZTO).

In another embodiment, the coated solid-state electrolyte further comprises at least one additional component. In an embodiment of interest, the additional component is selected from the group consisting of ionic conductors, inorganic particles, glass or ceramic particles, nanoceramics, salts and other similar additives.

In another embodiment, the coated solid-state electrolyte further comprises a second coating material deposited on at least a portion of an opposite surface of the solid-state electrolyte. In an embodiment of interest, the second coating material is a succinonitrile-based coating material. For example, the succinonitrile-based coating material comprises a lithium salt.

According to another aspect, the present technology relates to an electrochemical cell comprising a negative electrode, a positive electrode and a coated solid-state electrolyte as defined herein.

In one embodiment, the metal-based coating layer of the coated solid-state electrolyte faces the negative electrode.

In another embodiment, if present, the second coating material of the coated solid-state electrolyte faces the positive electrode.

In another embodiment, the negative electrode comprises an electrochemically active material comprising an alkali metal, an alkaline earth metal, an alloy comprising at least one alkali or alkaline earth metal, a non-alkali and non-alkaline earth metal, or an alloy or an intermetallic compound. In an embodiment of interest, the electrochemically active material of the negative electrode comprises lithium metal or an alloy thereof.

In another embodiment, the positive electrode comprises an electrochemically active material. In an embodiment of interest, the electrochemically active material of the positive electrode comprises is selected from the group consisting of metal oxides, lithium metal oxides, metal phosphates, lithium metal phosphates, titanates, lithium titanates, metal fluorophosphates, lithium metal fluorophosphates, metal oxyfluorophosphates, lithium metal oxyfluorophosphates, metal sulfates, lithium metal sulfates, metal halides (e.g. fluorides), lithium metal halides (e.g. fluorides), sulfur, lithium sulfur, selenium, lithium selenium and a combination of at least two thereof. For example, the metal of the electrochemically active material is selected from the group consisting of titanium (Ti), iron (Fe), magnesium (Mg), manganese (Mn), vanadium (V), nickel (Ni), cobalt (Co), aluminum (AI), zirconium (Zr), zinc (Zn), niobium (Nb), and a combination of at least two thereof.

In another embodiment, the positive electrode further comprises at least one electronically conductive material. In an embodiment of interest, the electronically conductive material is selected from the group consisting of carbon black, acetylene black, graphite, graphene, carbon fibers, carbon nanofibers, carbon nanotubes and a combination of at least two thereof.

In another embodiment, the positive electrode further comprises at least one binder. In an embodiment of interest, the binder is selected from the group consisting of a polymeric binder of polyether type, a fluorinated polymer and a water-soluble binder.

In another embodiment, the positive electrode further comprises at least one additional component. In an embodiment of interest, the additional component is selected from the group consisting of ionic conductors, inorganic particles, glass or ceramic particles, nanoceramics, salts and other similar additives.

According to another aspect, the present technology relates to a battery comprising at least one electrochemical cell as defined herein.

In one embodiment, said battery is selected from the group consisting of a lithium battery, a lithium-ion battery, a sodium battery, a sodium-ion battery, a potassium battery, a potassium-ion battery, a magnesium battery, and a magnesium-ion battery. In an embodiment of interest, said battery is selected from the group consisting of a lithium battery or a lithium-ion battery.

### BRIEF DESCRIPTION OF THE DRAWINGS

FIG. 1 shows schematic representations in (a) of a process for the preparation of a solid-state electrolyte by fast sintering process; and in (b) of a process for the preparation of a coated solid-state electrolyte by a melt-quenching process according to possible embodiments.

FIG. 2(a) is a schematic representation of a rapid heating experiment setup according to one embodiment; (b) a digital photograph showing the rapid heating experiment setup; and (c) a graph of the measured temperature as a function of the current passing through a graphite heating element.

FIG. 3 presents X-ray diffraction (XRD) patterns obtained for a pristine LLZTO and a AgSn_{0.6}Bi_{0.4}Oₓ coated LLZTO, as described in Example 2 (a).

FIG. 4 shows in (a) X-ray photoelectron spectroscopy (XPS) survey spectra of a AgSn_{0.6}Bi_{0.4}Oₓ coated LLZTO obtained before and after 600 seconds of argon ion sputtering; in (b) depth profiles of the elemental composition near the surface of the AgSn_{0.6}Bi_{0.4}Oₓ coated LLZTO; and in (c) deconvoluted XPS fine spectra of Sn, Bi, and Ag for the AgSn_{0.6}Bi_{0.4}Oₓ coated LLZTO, as described in Example 2 (b).

FIG. 5 shows electrochemical impedance spectroscopy (EIS) measurements of fresh and air-exposed AgSn_{0.6}Bi_{0.4}Oₓ/LLZTO/AgSn_{0.6}Bi_{0.4}Oₓ electrolyte recorded at different air-exposure time intervals, as described in Example 2 (b).

FIG. 6 is a schematic representation of the differences in the interfacial region between the pristine LLZTO and LLZTO/AgSn_{0.6}Bi_{0.4}Oₓ upon contact with lithium metal, as described in Example 2 (b).

FIG. 7 shows scanning electron microscope (SEM) images in (a)-(c) of a pristine LLZTO surface (scale bars represent 20 μm, 5 μm and 1 μm, respectively), and in (d) of a AgSn_{0.6}Bi_{0.4}Oₓ coated LLZTO surface (scale bar represents 1 μm), as described in Example 2 (c).

FIG. 8 shows in (a) a SEM image of a AgSn_{0.6}Bi_{0.4}Oₓ coated LLZTO surface; in (b) La, Zr, C, Ag, Sn, and Bi elemental mapping images obtained by energy dispersive X-ray spectrometry (EDS); and in (c) a graph showing the results of the EDS analysis obtained for the area outlined in (a), as described in Example 2 (c). Scale bar represents 1 μm.

FIG. 9 shows in (a) a SEM image of a cross section of a AgSn_{0.6}Bi_{0.4}Oₓ coated LLZTO surface; and in (b) Zr, O, La, Bi, Sn, and Ag elemental mapping images obtained by EDS obtained for the area outlined in (a), as described in Example 2 (c). Scale bar represents 10 μm.

FIG. 10 presents in (a) a low magnification SEM image and in (b) a high magnification SEM image showing the interface between an AgSn_{0.6}Bi_{0.4}Oₓ coated LLZTO solid-state electrolyte and a lithium metal negative electrode, as described in Example 2 (c). Scale bars represent 10 μm and 2 μm, respectively.

FIG. 11 shows in (a) a high-angle annular dark field scanning transmission electron microscopy (HAADF-STEM) image of a AgSn_{0.6}Bi_{0.4}Oₓ coated LLZTO nanoparticle; in (b) the corresponding element mapping images respectively of O, Zr, La, Ag, Sn, and Bi; in (c) an atomic resolution HAADF-STEM image taken near the edge of the AgSn_{0.6}Bi_{0.4}Oₓ coated LLZTO nanoparticle and in inset its corresponding fast Fourier transform (FFT) pattern; in (d) a high magnification HAADF-STEM image of the edge of the AgSn_{0.6}Bi_{0.4}Oₓ coated LLZTO nanoparticle along the zone axis; and in (e) an FFT filtered HAADF-STEM image overlaid respectively by yellow and blue false-colors images representing the LLZTO and the Bi—Sn alloy, as described in Example 2 (d).

FIG. 12 shows in (a) Nyquist plots of symmetric cells comprising LLZTO solid-state electrolytes coated by different Sn-based alloys; in (b) an enlarged view of the Nyquist plots showing the areas representing the interfacial resistance; and in (c) Nyquist plots of symmetric cells comprising LLZTO solid-state electrolytes coated with different Sb-based alloys, as described in Example 3 (c).

FIG. 13 shows graphs of the rate performance of symmetric cells comprising LLZTO solid-state electrolytes coated by different Sn and Sb-based coatings, as described in Example 3(d).

FIG. 14 shows in (a) Nyquist plots of symmetric cells comprising LLZTO solid-state electrolytes coated with Ag—Sn alloys doped by different content of Bi; in (b) to (f) graphs of the rate performance of symmetric cells comprising LLZTO solid-state electrolytes respectively coated with AgSn_{1-y}Bi_{y}Oₓ with y being 1, 0.8, 0.6, 0.4 and 0; in (g) and (h) graphs of the cyclic performance of a symmetric cell comprising a AgSn_{0.6}Bi_{0.4}Oₓ coated LLZTO solid-state electrolyte respectively cycled at a current density/capacity of 1 mA cm⁻²/1 mAh cm⁻² and 1.2 mA cm⁻²/0.1 mAh cm⁻², as described in Example 3(d).

FIG. 15 shows graphs of the cyclic performance of symmetric cells consisting of Li/AgSn_{0.6}Bi_{0.4}Oₓ-LLZTO-AgSn_{0.6}Bi_{0.4}Oₓ/Li in (a) under a current density of 0.5 mA cm⁻² and areal capacity of 1 mAh cm⁻²; in (b) under a current density of 0.5 mA cm⁻² and areal capacity of 0.1 mAh cm⁻²; an in (c) under a current density of 1 mA cm⁻² and areal capacity of 1 mAh cm⁻² (enlarged view of the last 5 cycles for the symmetric cell shown in FIG. 14(g)), as described in Example 3(d).

FIG. 16 shows in (a) a graph of the cyclic performance of a symmetric cell consisting of Li/AgSn_{0.6}Bi_{0.4}Oₓ-LLZTO-AgSn_{0.6}Bi_{0.4}Oₓ/Li that was stopped and disassembled for SEM analysis after being cycled for 650 hours; an in (b) to (e) SEM images recorded at the cross section of lithium and LLZTO/AgSn_{0.6}Bi_{0.4}Oₓ for the symmetric cell obtained in (a), as described in Example 3(d). Scale bars represent 100 μm, 20 μm, 10 μm, and 2 μm, respectively.

FIG. 17 is a cross-sectional SEM image showing the poor contact between lithium metal negative electrode and pristine LLZTO as described in Example 3(d). Scale bar represents 20 μm.

FIG. 18 shows in (a) and (b) graphs representing the specific capacity (mAh g⁻¹) and coulombic efficiency (%) as a function of the number of cycles for C-rate between 0.1 C and 1.0 C obtained for an electrochemical cell comprising a AgSn_{0.6}Bi_{0.4}Oₓ coated LLZTO solid-state electrolyte; and in (c) the corresponding charge-discharge profiles obtained at different C-rates, as described in Example 3(d).

FIG. 19 shows in (a) a schematic illustration of the diffusion pathway of lithium vacancies in Li₂AgSn_{0.6}Bi_{0.4}; and in (b) the corresponding diffusion barrier, as described in Example 3 (e).

FIG. 20 shows a LLZTO pellet (a) before and (b) after densification; (c) digital photograph displaying the blue light emitted from the densified LLZTO electrolyte upon UV radiation, as described in Example 6.

FIG. 21 presents in (a) XRD patterns for an LLZTO solid-state electrolyte obtained before and after densification via rapid heating; in (b) a SEM image showing the surface morphology of the LLZTO solid-state electrolyte with insets displaying a graph of the grain size distribution and digital photograph of the LLZTO solid-state electrolyte; in (c) a Nyquist plot exhibiting the bulk resistance of the LLZTO solid-state electrolyte tested with two blocking electrodes; in (d) a partial periodic table indicating the elements of interest labeled by the orange-colored squares, elements which are in their liquid, solid and gas form at a temperature of 1100° C., are identified in dark blue, light blue and green, respectively; in (e) Nyquist plots showing the interfacial resistance of LLZTO coated with Bi—, Al—, Cu—, Sn—and Sb-based material; in (f) Nyquist plots showing the interfacial resistance of LLZTO coated with Cu—, Sn—and Cu—Sn-based (i.e., Cu₃SnOₓ) materials; in (g) Nyquist plots showing the interfacial resistance of LLZTO coated with Cu₃SnOₓ at different treatment temperatures; in (h) a contour plot displaying the interfacial resistance between modified LLZTO and lithium metal with different Cu/Sn ratios and treatment temperatures, as described in Example 6.

FIG. 22 presents in (a) and (b) XRD patterns respectively for Al-LLZO and Al-LLZTO solid-state electrolytes obtained before and after rapid densification; in (c) and (d) SEM images showing the surface morphology of Al-LLZO and Al-LLZTO solid-state electrolytes, respectively; and in (e) and (f) graphs of the grain size distributions of Al-LLZO and Al-LLZTO solid-state electrolytes, respectively, as described in Example 6.

FIG. 23 is an electrochemical impedance spectroscopy (EIS) spectrum recorded for a Li|LLZTO| Li symmetric cell, as described in Example 6.

FIG. 24 presents in (a) EIS spectra of symmetric cells consisting of LLZTO solid-state electrolytes coated with Cu₆Sn₅Oₓ with Cu:Sn molar ratio of 6:5 synthesized at different temperatures; in (b) EIS spectra comparing the interfacial resistance of symmetric cells comprising garnet-type solid-state electrolytes with different Sn-based compositions, as described in Example 6.

FIG. 25 presents in (a) low and in (b) high magnification SEM images revealing the Cu_{z}Sn_{y}Oₓ coating on the LLZTO surface; in (c) a schematic illustration of a mechanism for the formation of the Cu_{z}Sn_{y}Oₓ coating material via the melt-quenching process; in (d) XRD spectra of pristine and modified LLZTO solid-state electrolytes, respectively; in (e) XPS spectra recorded for the fresh and etched surface of the Cu_{z}Sn_{y}Oₓ-coated LLZTO solid-state electrolyte, respectively; in (f) a XPS high resolution spectrum of Sn 3d; in (g) a XPS high resolution spectrum of Cu 2p, as described in Example 6.

FIG. 26 shows in (a) a high magnification SEM image showing the surface of a pristine LLZTO solid-state electrolyte; and in (b) a high magnification SEM image showing the morphology of a Cu and Sn physical mixture obtained before the melt-quenching process, as described in Example 6.

FIG. 27 shows EIS spectra showing (a) increased interfacial resistance after exposing uncoated LLZTO to air for 15 minutes as compared to (b) almost identical profiles obtained for fresh and exposed Cu₃SnOₓ-coated LLZTO solid-state electrolytes tested in symmetric cells, as described in Example 6.

FIG. 28 presents in (a) a graph of the calculated Cu and Sn adsorption energies as a function of the number of layers; in (b) snapshots of Ab initio molecular dynamics (AIMD) simulations showing a side view of the interface between a Cu—Sn alloy coating and a LLZTO solid-state electrolyte; in (c) and (d) low and high magnification SEM images of the interface between newly plated lithium and Cu—Sn-coated LLZTO solid-state electrolyte; and in (e) EDS elemental mapping of the same area, as described in Example 6.

FIG. 29 presents in (a) a graph of the mean squared displacement (MSDs) of Cu and Sn atoms in Cu or Cu₃Sn calculated by AIMD simulations and plotted against time; and in (b) charge density differences after full adsorption of Cu and a Cu—Sn alloy on the surface of a LLZTO solid-state electrolyte, as described in Example 6.

FIG. 30 is a voltage profile of lithium stripping in a symmetric cell comprising a Cu₃SnOₓ-coated LLZTO solid-state electrolyte, as described in Example 6.

FIG. 31 is a high magnification SEM image of a lithium/pristine LLZTO interface obtained at a low accelerating voltage of 5 kV to enhance the contrast different between the lithium metal and the gap between lithium and LLZTO, as described in Example 6.

FIG. 32 presents in (a) and (b) graphs representing the rate performances of Cu₃SnOₓ-coated LLZTO solid-state electrolytes tested in symmetric cells at room temperature and at 60° C., respectively; in (c) and (d) graphs representing the potential (V vs Li/Li⁺) as a function of time (h) obtained for Cu₃SnOₓ-coated LLZTO solid-state electrolytes tested in symmetric cells at room temperature and at 60° C., respectively; and in (e) operando EIS spectra of the symmetric cell cycled under a current density of 4 mA cm⁻² at a temperature of 60° C., as described in Example 6.

FIG. 33 shows an enlarged view of several typical cycles recorded at about 3 000 hours acquired from FIGS. 32(c) and 32(d).

FIG. 34 presents voltage profiles of symmetric cells comprising pristine LLZTO, Sn-coated LLZTO and Cu₆Sn₅-coated LLZTO solid-state electrolytes cycled at a current density of 0.2 mA cm⁻², as described in Example 6.

FIG. 35 presents in (a) a schematic illustration of the structure and composition of the all-solid-state electrochemical cell; in (b) Nyquist plots showing the impedances of all-solid-state electrochemical cells with LFP and NMC positive electrodes, respectively; in (c) a graph of the capacity and efficiency versus the cycle number for C-rate between 0.1 C and 1.0 C recorded for the all-solid-state electrochemical cell with an NMC positive electrode; in (d) charge and discharge profiles recorded at 1, 0.5, 0.2 and 0.1 C for the all-solid-state electrochemical cell with an NMC positive electrode; and in (e) a graph of the capacity and efficiency versus the cycle number recorded at 1 C for the all-solid-state electrochemical cell with an NMC positive electrode, as described in Example 6.

FIG. 36 presents in (a) a graph of the capacity and efficiency versus the cycle number recorded at 0.2 C; in (b) a graph of the capacity and efficiency versus the cycle number for C-rate between 0.1 C and 1.0 C recorded for an all-solid-state electrochemical cell with an LFP positive electrode and Cu₃SnOₓ-coated LLZTO solid-state electrolytes; and in (c) corresponding charge and discharge profiles recorded at 1, 0.5, 0.2 and 0.1 C, as described in Example 6.

FIG. 37 presents a graph of the capacity and efficiency versus the cycle number recorded at 1 C for a conventional liquid cell comprising an NMC positive electrode, as described in Example 6.

FIG. 38 presents XRD patterns of pristine LLZTO(Z) and LLZTO(LZ) solid-state electrolytes prepared by a Joule heating technique from different metal-oxide precursors, as described in Example 7.

FIG. 39 presents the SEM images from a surface of the pristine LLZTO(Z) and LLZTO(LZ) solid-state electrolytes prepared by the Joule heating technique from different metal-oxide precursors, as described in Example 7.

FIG. 40 presents the EIS spectrum of the pristine LLZTO(Z) and LLZTO(LZ) solid-state electrolytes prepared by the Joule heating technique from different metal-oxide precursors, as described in Example 7.

FIG. 41 presents the EIS spectrum of a Sn:SnF₂-coated LLZTO(LZ) solid-state electrolyte prepared by the Joule heating technique from different Sn:SnF₂ ratios, as described in Example 8.

FIG. 42 is a graph comparing the EIS spectrum of the pristine LLZTO(LZ) solid-state electrolyte and the Sn:SnF₂ (10:3)-coated LLZTO(LZ) solid-state electrolyte prepared by the Joule heating technique in Examples 7 and 8, respectively.

FIG. 43 shows graphs representing rate performances of Li/Sn—SnF₂-LLZTO-Sn—SnF₂/Li with different Sn:SnF₂ ratios (10:0.5, 10:1, 10:2, 10:3, 10:4, 10:5) tested in a symmetric cell at a temperature of about 60° C. (step: 0.2 mA cm⁻² for 6 minutes).

### DETAILED DESCRIPTION

The following detailed description and examples are illustrative and should not be interpreted as further limiting the scope of the invention. On the contrary, it is intended to cover all alternatives, modifications and equivalents that can be included as defined by the present description. The objects, advantages and other features of the present solid-state electrolytes, systems, methods and their uses will be more apparent and better understood upon reading the following non-restrictive description and references made to the accompanying drawings.

All technical and scientific terms and expressions used herein have the same definitions as those commonly understood by the person skilled in the art when relating to the present technology. The definition of some terms and expressions used herein is nevertheless provided below for clarity purposes.

When the term “about” is used herein, it means approximately, in the region of or around. When the term “about” is used in relation to a numerical value, it modifies it; for example, by a variation of 10% above and below its nominal value. This term can also take into account the rounding of a number or the probability of random errors in experimental measurements, for instance, due to equipment limitations.

When a range of values is mentioned herein, the lower and upper limits of the range are, unless otherwise indicated, always included in the definition. When a range of values is mentioned in the present application, then all intermediate ranges and subranges, as well as individual values included in the ranges, are intended to be included.

It is worth mentioning that throughout the following description when the article “a” is used to introduce an element, it does not have the meaning of “only one” and rather means “one or more”. It is to be understood that where the specification states that a step, component, feature, or characteristic “may”, “might”, “can” or “could” be included, that particular component, feature or characteristic is not required to be included in all alternatives.

The present application describes solid-state electrolytes, their methods and systems for their production as well as their use in electrochemical cells and in batteries, for example, in all-solid-state metal batteries.

The present technology relates to a process for producing a coated solid-state electrolyte comprising a metal-based coating layer deposited on at least a portion of a surface of a solid-state electrolyte. More particularly, the process comprises the steps of:
(i) depositing the precursor powder of a metal-based coating material on at least a portion of a surface of a solid-state electrolyte;
(ii) subjecting the precursor powder of the metal-based coating material to a rapid heating method to produce a melted metal-based coating material; and
(iii) solidifying the melted metal-based coating material to produce the coated solid-state electrolyte.

It is to be understood that the process as described herein relies on a heat treatment technique, a fast sintering technique, or a melt-quenching technique. It is to be understood that the term “rapid heating method” refers to the entire heat treatment process which can include, for example, heating, dwelling, and cooling steps.

According to one example, the step of depositing the precursor powder of the metal-based coating material on at least a portion of a surface of a solid-state electrolyte can be performed by any compatible method. The deposition step can be performed by a mechanical or a chemical coating process.

For instance, the deposition step can be performed by a powder deposition technique. The powder deposition technique can be, for example, a powder spreading technique, a powder rubbing technique, or a powder dipping technique. However, various other methods could be used to apply a precursor powder of a metal-based coating material on the surface of the solid-state electrolyte.

According to another example, the precursor powder of the metal-based coating material can adhere to the surface of the solid-state electrolyte via attractive forces such as Van der Waals forces.

According to another example, the process optionally further includes a step of removing an excess amount of the precursor powder of the metal-based coating material prior to the step of subjecting the precursor powder of the metal-based coating material to the rapid heating method. The step of removing the excess amount of the precursor powder of the metal-based coating material can be performed by any compatible method. For example, a compressed gas can be used to simply blow off excess precursor powder of the metal-based coating material.

According to another example, the rapid heating method can be performed by any compatible method. For example, the rapid heating method can be selected from a Joule heating method, a microwave radiation method, a spark plasma sintering method, an induction heating method, a laser sintering method, an infrared radiation method, and an electric pulse consolidation method. According to one example of interest, the rapid heating method is the Joule heating method (also known as resistive, resistance, or Ohmic heating method).

It is to be understood that the precursor powder of the metal-based coating material is subjected to the rapid heating method for a period, at a temperature and at a temperature ramp rate sufficient to melt at least one component of the precursor powder of the metal-based coating material.

According to another example, the rapid heating method can be carried out for a period of less than about 90 s. For example, the rapid heating method can be carried out for a period of less than about 80 s, or less than about 70 s, or less than about 60 s, or less than about 50 s, or less than about 40 s, or less than about 30 s, or less than about 25 s, or less than about 20 s, or less than about 15 s, or less than about 10 s. Alternatively, the rapid heating method can be carried out for a period in the range of from about 1 s to about 90 s, limits included. For example, the rapid heating method can be carried out for a period in the range of from about 1 s to about 80 s, or from about 1 s to about 70 s, or from about 1 s to about 60 s, or from about 1 s to about 50 s, or from about 1 s to about 40 s, or from about 1 s to about 30 s, or from about 1 s to about 25 s, or from about 1 s to about 20 s, or from about 1 s to about 15 s, or from about 1 s to about 10 s, or from about 2 s to about 10 s, or from about 3 s to about 10 s, limits included. According to one example of interest, the rapid heating method can be carried out for a period of about 3 s.

According to another example, the rapid heating method can be carried out at a temperature in the range of from about 550° C. to about 1400° C., limits included. For example, the rapid heating method can be carried out at a temperature in the range of from about 600° C. to about 1350° C., or from about 650° C. to about 1300° C., or from about 700° C. to about 1250° C., or from about 700° C. to about 1200° C., limits included.

According to another example, the rapid heating method can be carried out at a heating temperature ramp rate of from about 5×10²° C. min⁻¹ to about 1.44×10⁴° C. min⁻¹, limits included. For example, the rapid heating method can be carried out at a heating temperature ramp rate of about 3×10³° C. min⁻¹. Alternatively, the rapid heating method can be isothermal and can be carried out at a constant heating temperature. Alternatively, the rapid heating method can have a substantially short initial heating ramp, for example, heating from ambient temperature to a final temperature in as low as about 0 s. Alternatively, the rapid heating method can include at least one heating temperature ramp and at least one isothermal heating cycle.

According to another example, the solidifying step can be performed by any compatible method. According to one example of interest, the solidifying step can be a rapid quenching step or a rapid cooling step to form a substantially uniform metal-based coating layer on the surface of the solid-state electrolyte. For instance, the solidifying step can be carried out at a cooling temperature ramp rate in the range of from about 5×10²° C. min⁻¹ to about 4.8×10³° C. min⁻¹, limits included. For example, the solidifying step can be carried out at a cooling temperature ramp rate of about 3×10³° C. min⁻¹. Alternatively, the solidifying step can be isothermal and can be carried out at a constant cooling temperature. Alternatively, the solidifying step can have a substantially short initial cooling temperature ramp, for example, cooling from a first temperature to ambient temperature in as low as about 0 s. Alternatively, the solidifying step can include at least one cooling temperature ramp and one at least one isothermal cooling cycle.

According to another example, the process optionally further includes a step of preparing the solid-state electrolyte before step (i). Any compatible method for preparing a solid-state electrolyte is contemplated. In some examples, the solid-state electrolyte is a garnet-type solid-state electrolyte and can be obtained by a traditional solid-state synthesis or by a fast sintering technique.

For example, the solid-state electrolyte powder precursors can be weighted to obtain the desired solid-state electrolyte. The raw powder can then be substantially uniformly mixed, for example, for about 10 hours by ball milling at a speed of about 300 rpm. After mixing, the raw powder can be pressed into pellets and annealed, for example, by a rapid heating method or in a muffle furnace at a temperature of about 900° C. for about 12 hours.

According to another example, the process optionally further includes a step of densifying the solid-state electrolyte. The densification step can be performed by any compatible method. For instance, the densification step can be performed by a heat treatment technique to substantially improve final pellet density. For instance, the densification step can be performed by a rapid heating method such as a Joule heating method, a microwave radiation method, a spark plasma sintering method, an induction heating method, a laser sintering method, an infrared radiation method, and an electric pulse consolidation method. For example, the rapid heating method can be carried out under the conditions mentioned above. According to one example of interest, the densification step can be performed by a Joule heating method, for example, for about 10 seconds.

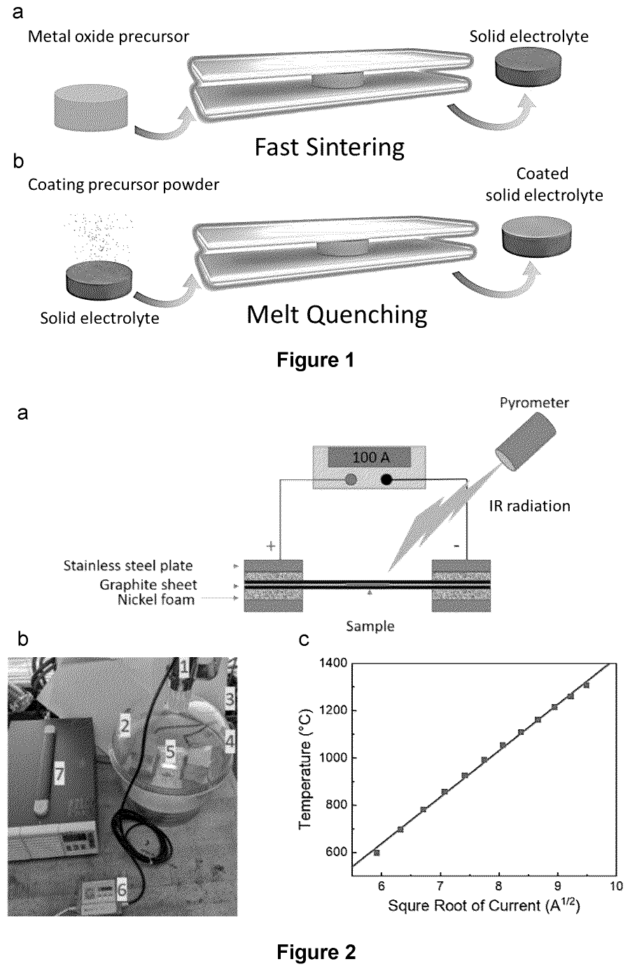

For a more detailed understanding of the present technology, reference is first made to FIG. 1, which provides a schematic representation in (a) of a process for producing a pristine solid-state electrolyte, and in (b) of a process for producing a coated solid-state electrolyte in accordance with a possible embodiment.

As illustrated in FIG. 1(b), the deposition step can be performed by a powder coating process that involves spreading the metal-based coating material precursor powder on at least a portion of a surface of the solid-state electrolyte. The solid-state electrolyte can then be transferred in a rapid melt-quenching apparatus with the surface coated with the metal-based coating material precursor powder facing upwards. The metal-based coating material precursor powder can then be subjected to a rapid increase in temperature to substantially melt at least one component of the precursor powder of the metal-based coating material to form a melted metal-based coating material. The melted metal-based coating material can substantially or completely spread across the surface of the solid-state electrolyte. The melted metal-based coating material can then be subjected to a rapid decrease in temperature thereby solidifying the melted metal-based coating material to produce the coated solid-state electrolyte.

According to another example, the process optionally further includes a step of depositing a second coating material on at least a portion of an opposite surface of the solid-state electrolyte to form a second coating layer. It is to be understood that the second coating layer is deposited on a surface opposite to the surface of the solid-state electrolyte on which the metal-based coating layer is deposited.

Reference is now made to FIG. 2(b), which provides a digital photograph of a rapid heating apparatus for producing a pristine solid-state electrolyte and/or a coated solid-state electrolyte in accordance with a possible embodiment. The apparatus for producing a pristine solid-state electrolyte and/or a coated solid-state electrolyte via a rapid heating method requires to be able to provide a substantially high temperature environment with a substantially high heating and cooling rate. Any compatible apparatus is contemplated.

A laboratory scale rapid heating apparatus was built by modifying a previously reported ultrafast high-temperature sintering device (Wang, Chengwei, et al. “A general method to synthesize and sinter bulk ceramics in seconds.” Science 368.6490 (2020): 521-526). The laboratory scale rapid heating apparatus was used to carry out all the heat treatment of the present disclosure. As illustrated in FIG. 2(b), the rapid heating apparatus can include a pyrometer (1), a heating chamber with rubber sealing O-ring (2), electrical connections (3), a gas inlet/outlet (4), a heating element (5), a transducer (6), and a power source (7).

Still referring to FIG. 2(b), any suitable heating element (5) by which the passage of an electric current through a conductor produces a rise in temperature is contemplated. For example, a graphite sheet can be an effective heating element. In order to prevent oxidation of the graphite, the heating element can be placed inside an air-tight chamber filled with an inert gas such as argon or nitrogen. The electrical current can be supplied by a programmable power source and the temperature of the heating element can be controlled by altering the amplitude of the electrical current. A pyrometer can be mounted on top of the chamber to measure the temperature, the infrared light radiated from the heating element can be captured by the pyrometer and converted to temperature. The temperature of the heating element is governed by Equation 1 where Q is the Joule heat, Qₗₒₛₛ represents the amount of heat transfer from the heating element to the ambient, I and R represent the current and resistance of the graphite heating element, respectively, A is the surface area of the graphite heating element, ε and σ are the emissivity and Stefan-Boltzmann constant, respectively, h is the heat transfer coefficient, T is the actual temperature of the heating element and T₀ is the ambient temperature.

$$Q = {Q}_{l o s s} = {I}^{2} R = h A ( T - {T}_{0} ) + ε σ A ( {T}^{4} - {T}_{0}^{4} ) \qquad ( 1 )$$

Provided that the heating element works at a substantially high temperature, the effect of thermal radiation becomes far greater than the heat conduction and convection. As a result, the temperature of the heating element can be approximated with Equation 2, where the actual temperature of the heating element is proportional to the square root of the current, and the measured temperature is consistent with the theoretical prediction (FIG. 2(c)).

$$T = {( \frac{ε σ A}{R} )}^{1 / 4} \sqrt{I} \qquad ( 2 )$$

According to another example, the process as defined herein can substantially reduce the sintering time compared to conventional methods for producing pristine solid-state electrolytes and/or coated solid-state electrolytes. For example, the process as defined herein based on a rapid heating method can effectively reduce the sintering time from several hours (about 12 hours for conventional solid-state synthesis) to a few seconds (for example, for less than about 25 seconds), thereby substantially reducing the lithium loss and effectively merging the grains toward higher material quality.

The present technology also relates to a coated solid-state electrolyte obtained by the process as defined herein. A coated solid-state electrolyte obtainable by the process as defined herein is also contemplated.

According to one example, the metal-based coating material can form a uniform coating layer on the surface of the solid-state electrolyte. For example, the metal-based coating material can form a substantially uniform metal-based coating layer on the surface of the solid-state electrolyte. Alternatively, the metal-based coating material can form a coating layer on at least a portion of the surface of the solid-state electrolyte. For instance, the metal-based coating can be heterogeneously dispersed on the surface of the solid-state electrolyte. According to one example of interest, the metal-based coating material forms a substantially uniform metal-based coating layer on the surface of the solid-state electrolyte.

According to another example, the metal-based coating material is selected from the group consisting of a metallic element, a metal alloy, a metal oxide, a fluorinated metal, and a combination of at least two thereof.

In some examples, the metal-based coating material is a metallic element. The metallic element can be a metal or a metalloid, for example, a metal or a metalloid selected from the group consisting of Al, Cu, Ag, Sn, Sb, and Bi. In some examples of interest, the metallic element is Cu, Ag, or Sn.

In some other examples, the metal-based coating material is a metal alloy, for example, a binary, ternary, or quaternary metal alloy. The metal alloy can include a first metallic component selected from the groups 14 and 15 elements and a second metallic component, wherein the second metallic component is different from the first metallic component. For example, the second metallic component can be an alkali metal, an alkali earth metal, a transition metal, a post-transition metal, a metalloid, or a lanthanide. In some examples of interest, the first metallic component is selected from Sn, Sb, and Bi and the second metallic component is selected from the group consisting of Al, Mn, Co, Ni, Cu, Ag, Sn, Sb, La, Tb, and Bi. Non-limiting examples of metal alloy include Sn—Mn, Sn—Co, Sn—Ni, Sn—Cu, Sn—Cu—Tb, Sn—Ag, Sn—La, Sn—Bi—Ag, Sb—Cu, Sb—Ag, and Bi—Ag-based alloy. In some examples of interest, the metal alloy is Cu₃Sn or Cu₆Sn₅. In some other examples of interest, the metal alloy is AgSnₓBi₁₋ₓ, where x is 0≤x≤1. For example, x can be 1, 0.8, 0.6, 0.4 or 0 and the metal alloy can be selected from the group consisting of AgSn, AgSn_{0.8}Bi_{0.2}, AgSn_{0.6}Bi_{0.4}, AgSn_{0.4}Bi_{0.6}, and AgBi.

In some other examples, the metal-based coating material is a fluorinated metal, for example, the fluorinated metal can be selected from the group consisting of SnF₂, SnF₄, ZnF₂, InF₃, GaF₃, SbF₃, TiF, PbF₂, CuF₂, BiF₃, AlF₃, AgF, and LiF.

In some other examples, the metal-based coating material is a metal oxide, for example, the metal oxide can be selected from the group consisting of SnO, SnO₂, CuO, Cu₂O, Bi₂O₃, Al₂O₃, and Ag₂O.

According to another example, the metal-based coating material can be selected for its melting temperature. For example, at least one component of the metal-based coating material precursors is preferably liquid at the temperature at which the rapid heating method is carried out. The metal-based coating material can also be selected for its ability to undergo a chemical reaction with lithium metal to form a substantially high lithium conductive phase.

According to another example, the metal-based coating material optionally further includes at least one doping element that could be included in smaller amounts, for example, to modulate or optimize its properties. For example, the metal-based coating material can be doped by the partial substitution of the metal with other elements. For instance, the metal-based coating material can be slightly doped with at least one doping element selected for its ability to reduce the energy barrier for Li⁺ diffusion. For example, the metal-based coating material can be doped with Bi.

According to another example, the solid-state electrolyte is in the form of a pellet, for example, the metal-based coating layer can be deposited on at least a portion of a surface of a solid-sate electrolyte configured to face a negative electrode of an electrochemical cell.

According to another example, the solid-state electrolyte can be a glass or ceramic solid-state electrolyte, preferably a ceramic solid-state electrolyte. For example, the solid-state electrolyte can be a garnet-type solid-state electrolyte. Non-limiting examples of garnet-type solid-state electrolytes include Li₇La₃Zr₂O₁₂ (LLZO), Li_{6.25}Al_{0.25}La₃Zr₂O₁₂ (Al-LLZO), Li_{6.5}La₃Zr_{1.5} Ta_{0.5}O₁₂ (LLZTO), Li_{6.35}Al_{0.05}La₃Zr₂Ta_{0.5}O₁₂ (Al-LLZTO), Li_{6.25}Nd₃Zr_{1.5}Ta_{0.5}O₁₂ (LNZTO), Li_{6.25}Sm₃Zr_{1.5} Ta_{0.5}O₁₂ (LSZTO), and Li_{6.25}(Sm_{0.5}La_{0.5})₃Zr_{1.5}Ta_{0.5}O₁₂ (LSZTO). For example, the garnet-type electrolyte is selected from the group consisting of Li₇La₃Zr₂O₁₂ (LLZO), Li_{6.25}Al_{0.25}La₃Zr₂O₁₂ (Al-LLZO), Li_{6.5}La₃Zr_{1.5} Ta_{0.5}O₁₂ (LLZTO), and Li_{6.35}Al_{0.05}La₃Zr₂Ta_{0.5}O₁₂ (Al-LLZTO).

Depending on the desired garnet-type solid-state electrolyte final composition, the oxide precursors used in the preparation of said garnet-type solid-state electrolyte can be single metal oxides such as Li₂O, ZrO₂, Ta₂O₅, Al₂O₃, Nd₂O₃, Sm₂O₃, and La₂O₃, or bimetallic oxides such as LiZrO₃, LiLaO₃, LiNdO₂, LiSmO₂, LiTaO₃, La₂Zr₂O₇, La_{0.6}Sm_{1.4}O₃, and AlLiO₂, or ternary metal oxides such as Li₇La₃Zr₂O₁₂, LizNd₃Zr₂O₁₂, LisLa₃Ta₂O₁₂, LiLa₂ TaO₆, LaZrTa₃O₁₁, LaNdZr₂O₇, La_{0.25}Sm_{0.25}Zr_{0.5}O_{1.75}, and Li_{0.5}La₂Al_{0.5}O₄, or the oxide precursors can be a combination of thereof.

According to another example, the solid-state electrolyte optionally further includes at least one additional component or additive, such as ionically conductive materials, inorganic particles, glass or ceramic particles; for instance, nano-ceramics (for example, aluminium oxide (Al₂O₃), titanium dioxide (TiO₂), silicon dioxide (SiO₂) and other similar compounds), and the like. For instance, the additional component or additive can be selected from NASICON, LISICON, thio-LISICON, garnet, sulfide, sulfide-halide, phosphate, thio-phosphate, and their combinations, in crystalline and/or amorphous form. In one example, the additional component or additive is substantially dispersed within the electrolyte. Alternatively, the additional component or additive can be in a separate layer.

According to another example, the solid-state electrolyte optionally further includes a second coating material, the second coating material forming a second coating layer. If present, the second coating material can be deposited on at least a portion of an opposite surface of the solid-state electrolyte. It is to be understood that the second coating layer is deposited on at least a portion of a surface opposite to the surface of the solid-state electrolyte on which the metal-based coating layer is deposited. For more clarity, if present, the second coating layer can be deposited on at least a portion of a surface of a solid-sate electrolyte configured to face a positive electrode of an electrochemical cell. For example, the second coating material can be selected for its ability to improve interfacial contacts between the positive electrode and the solid-state electrolyte. For example, the second coating material can be a succinonitrile-based coating material and optionally further includes a lithium salt such as lithium bis(trifluoromethanesulfonyl)imide (LiTFSI).

According to one alternative, the electrolyte can be a polymer-ceramic hybrid solid-state electrolyte. The polymer-ceramic hybrid solid-state electrolyte can be in a multilayer configuration. For example, the polymer-ceramic hybrid solid-state electrolyte can include a layer of a solid polymer electrolyte including a salt in a solvating polymer and a layer of ceramic electrolyte, the metal-based coating layer being deposited on at least a portion of a surface of the ceramic layer. It is to be understood that the solid polymer electrolyte layer is deposited on a surface opposite to the surface of the ceramic layer on which the metal-based coating layer is deposited.

In some examples, the ceramic can be a garnet-type solid-state electrolyte as defined above. The solid polymer electrolyte can be selected from any known solid polymer electrolytes compatible with the various elements of an electrochemical cell. For instance, the solid polymer electrolyte can be selected for its compatibility with lithium and the positive electrode. Solid polymer electrolytes may generally include one or more solid polar polymers, optionally crosslinked, and a salt. Polyether-type polymers can be used, such as those based on polyethylene oxide (PEO), but several other compatible polymers such as polynitrile-type polymers are also known for the preparation of solid polymer electrolytes. The polymer can be further crosslinked. Examples of such polymers include star-shaped or comb-shaped multi-branch polymers such as those described in PCT application number WO2003/063287 (Zaghib et al.).

For example, the salt can be an ionic salt, such as a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LIDCTA), lithium bis(pentafluoroethylsulfonyl)imide (LiBETI), lithium tetrafluoroborate (LiBF₄), lithium bis(oxalato) borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy) borate Li[B(OCOCF₃)₄] (LITFAB), lithium bis(1,2-benzenediolato (2-)-O,O′)borate [B(C₆O₂)₂] (LiBBB), and their combinations.

The present technology also relates to an electrochemical cell comprising a negative electrode, a positive electrode and a coated solid-state electrolyte as defined herein.

According to one example, the metal-based coating layer of the coated solid-state electrolyte faces the negative electrode.

According to another example, if present, the second coating material of the coated solid-state electrolyte faces the positive electrode.

According to another example, if present, the solid polymer electrolyte of the coated solid-state electrolyte faces the positive electrode.

According to another example, the negative electrode (counter-electrode) includes an electrochemically active material which may be any known material and will be selected for its electrochemical compatibility with the various elements of the electrochemical cell defined herein. Non-limiting examples of electrochemically active material of the negative electrode include an alkali metal, an alkaline earth metal, an alloy comprising at least one alkali or alkaline earth metal, a non-alkali and non-alkaline earth metal, or an alloy or an intermetallic compound. According to one example of interest, the electrochemically active material of the negative electrode can be lithium metal or an alloy thereof.

According to another example, the positive electrode includes an electrochemically active material which may be any known material and will be selected for its electrochemical compatibility with the various elements of the electrochemical cell defined herein. The electrochemically active material of the positive electrode can be in the form of particles. Non-limiting examples of electrochemically active materials include metal oxides, lithium metal oxides, metal phosphates, lithium metal phosphates, titanates, lithium titanates, metal fluorophosphates, lithium metal fluorophosphates, metal oxyfluorophosphates, lithium metal oxyfluorophosphates, metal sulfates, lithium metal sulfates, metal halides (such as fluorides), lithium metal halides (such as fluorides), sulfur, selenium and a combination of at least two thereof. For example, the electrochemically active material of the positive electrode can be selected from the group consisting of metal oxides, lithium metal oxides, metal phosphates, lithium metal phosphates and a combination of at least two thereof. For example, the metal of the electrochemically active material may be selected from the group consisting of titanium (Ti), iron (Fe), magnesium (Mg), manganese (Mn), vanadium (V), nickel (Ni), cobalt (Co), aluminum (Al), chromium (Cr), copper (Cu), antimony (Sb), zirconium (Zr), zinc (Zn), niobium (Nb), and a combination of at least two thereof when applicable. According to some examples of interest, the electrochemically active material of the positive electrode can be lithium iron phosphate (LiFePO₄, abbreviated as LFP) or lithium nickel manganese cobalt oxide (LiNiMnCoO₂, abbreviated as NMC)

According to another example, the electrochemically active material of the positive electrode may also be further doped with other elements or impurities, which may be included in smaller amounts, for example, to modulate or optimize its electrochemical properties. For example, the electrochemically active material of the positive electrode may be doped by the partial substitution of the metal with other elements. For instance, the electrochemically active material of the positive electrode may be doped with a transition metal (for example, Ti, V, Cr, Mn, Fe, Co, Ni, Cu, Zn or Y) and/or a non-transition element (for example, Mg, Al or Sb).

According to another example, the electrochemically active material of the positive electrode can be in the form of particles (for example, microparticles and/or nanoparticles) which can be freshly formed or of commercial sources and can further comprise a coating material. The coating material can be an electronically conductive material, for example, the coating can be a carbon coating.

According to another example, the positive electrode as described herein further optionally includes an electronically conductive material. Non-limiting examples of electronically conductive materials include carbon black (e.g. Ketjen™ black and Super P™), acetylene black (e.g. Shawinigan black and Denka™ black), graphite, graphene, carbon fibers (e.g. vapor grown carbon fibers (VGCFs), carbon nanofibers, carbon nanotubes and a combination of at least two thereof. According to some examples of interest, the electronically conductive material can be Super P™.

According to another example, the positive electrode as described herein further optionally includes a binder. For example, the binder can be selected for its compatibility with the various elements of the electrochemical cell. Any known compatible binder is contemplated. For instance, the binder can be a polymeric binder of polyether type, a fluorinated polymer, or a water-soluble binder. According to one example, the binder is a fluorinated polymer such as polyvinylidene fluoride (PVDF) and polytetrafluoroethylene (PTFE). According to another example, the binder is a water-soluble binder, such as styrene-butadiene rubber (SBR), acrylonitrile-butadiene rubber (NBR), hydrogenated NBR (HNBR), epichlorohydrin rubber (CHR), or acrylate rubber (ACM), optionally including a thickening agent such as carboxymethyl cellulose (CMC) or an acidic polymer like poly(acrylic acid) (PAA), poly(methacrylic acid) (PMMA) or a combination thereof. According to another example, the binder is a polymeric polyether binder; for example, a linear, branched and/or crosslinked binder based on polyethylene oxide (PEO), poly(propylene oxide) (PPO) or a combination of the two (or an EO/PO co-polymer), that optionally includes crosslinkable units. According to one example of interest, the binder is PVDF. According to another example of interest, the binder includes succinonitrile (SN), a lithium conductive salt (LiTFSI) and polyacrylonitrile (PAN).

According to another example, the positive electrode as described herein further optionally includes at least one additional component or additive such as ionic conductors, inorganic particles, glass or ceramic particles, nanoceramics (for example, aluminium oxide (Al₂O₃), titanium dioxide (TiO₂), silicon dioxide (SiO₂) and other similar compounds), salts (for example, lithium salts) and other similar components. For example, the additional component can be an ionic conductor selected from the group consisting of NASICON, LISICON, thio-LiSICON, garnets, sulfides, sulfur halides, phosphates and thio-phosphates, of crystalline and/or amorphous form, and a combination of at least two thereof.

The present technology also relates to a battery including at least one electrochemical cell as defined herein. For example, said battery can be a lithium or a lithium-ion battery, a sodium or a sodium-ion battery, a magnesium or a magnesium-ion battery, or a potassium or a potassium-ion battery. According to one example of interest, the battery is a lithium or a lithium-ion battery. According to another example of interest, the battery is an all-solid-state battery.

According to another example, the metal-based coating layer as defined herein can substantially stabilize the interface between the negative electrode and the solid-state electrolyte. In addition, the substantially uniform morphology and the lithiophilic property of the metal-based coating layer can substantially reduce or even eliminate the interfacial resistance, enabling dendrite-free lithium plating and stripping on the solid-state electrolyte interface even at a high current density of 20 mA cm⁻². The substantially uniform coating of the metal-based coating material on the surface of the solid-state electrolyte and the facile lithium diffusion via the metal-based coating layer can substantially improve the electrochemical performances. For example, the metal-based coating layer can substantially improve the cyclability.

To fully unlock the potential of solid-state electrolytes, the interfacial resistance between the solid-state electrolyte and the negative electrode should be substantially reduced. There are three prerequisites that need to be satisfied to negate the interfacial resistance: (i) the lithium diffusion through the interfacial layer should be much faster than that in the bulk solid-state electrolyte so that the lithium diffusion resistance be substantially negligible in the interfacial layer; (ii) the interfacial layer should be uniformly coated on the surface of the solid-state electrolyte to provide a uniform distribution of local current density across the interface during the lithium plating/stripping process; and (iii) the solid-state electrolyte should be chemically and electrochemically stable against the interfacial layer (Chen, Wan-Ping, et al. “Bridging interparticle Lit conduction in a soft ceramic oxide electrolyte.” Journal of the American Chemical Society 143, no. 15 (2021): 5717-5726). For example, many elemental metals or their alloys meet the first requirement because they generally possess a high diffusion rate when they alloy with a lithium metal negative electrode. However, there is a lack of effective and scalable approaches to uniformly coat an ultra-thin layer of metal or metal alloy onto the surface of the solid-state electrolyte. Previous studies employ either mechanical spreading or sputtering methods to form an interfacial layer on the solid-state electrolyte, while those methods are highly uncontrollable and often create a high quantity of uncoated areas that lead to the presence of the interfacial resistance despite the surface modification. Furthermore, with the use of different metal coating strategies the reported interfacial resistances still show a large variation from 5 to 150 Ωcm⁻² indicating that the complete elimination of such interfacial resistance remains a challenge.

The melt-quenching process as described herein can be used to apply a zero-resistance metal-based interfacial layer coating onto a surface of a solid-state electrolyte. The melt-quenching process as described herein uses a rapid heating/cooling device and can be used to in-situ form and coat a metal-based material onto the surface of the solid-state electrolyte. A wide range of metals with their binary and ternary compositions were explored as candidates for the interfacial layer, and their electrochemical performances were comprehensively evaluated. It was demonstrated that certain metallic elements in their binary and ternary alloys exhibit a synergetic effect that enables a uniform coating of the alloy onto the surface of the solid-state electrolyte while providing a zero lithium/solid-state electrolyte interfacial resistance. Several types of metal alloys, with AgSn_{0.6}Bi_{0.4}Oₓ as the most promising one, were found to endow the solid-state electrolyte with a negligible interfacial resistance with a lithium metal negative electrode. Advanced characterizations and theoretical calculations were conducted to unveil the mechanisms for the excellent interfacial stability of the coated solid-state electrolyte with the lithium metal negative electrode. The obtained results reveal a new mechanistic insight that is crucial for the further development of alloy-based interfacial layers.

### EXAMPLES

The following non-limiting examples are illustrative embodiments and should not be construed as further limiting the scope of the present invention. These examples will be better understood in combination with the accompanying Figures.

### Example 1-Synthesis of Densified Li_{6.5}La₃Zr_{1.5}Ta_{0.5}O₁₂ (LLZTO) Solid-State Electrolytes Coated with a Layer of Metal-Based Material

### (a) Solid-State Synthesis of Densified LLZTO Solid-State Electrolytes

Garnet-type solid-state electrolytes were prepared via a solid-state synthesis and densified by a modified rapid heating method (Wang, Chengwei, et al. “A general method to synthesize and sinter bulk ceramics in seconds.” Science 368.6490 (2020): 521-526).

Three different compositions of garnet-type solid-state electrolytes were synthesized, namely, Li_{6.25}Al_{0.25}La₃Zr₂O₁₂ (Al-LLZO), Li_{6.5}La₃Zr_{1.5}Ta_{0.5}O₁₂ (LLZTO), and Li_{6.35}Al_{0.05}La₃Zr₂Ta_{0.5}O₁₂ (Al-LLZTO). The respective precursor lithium hydroxide monohydrate (LiOH·H₂O), zirconium dioxide (ZrO₂), lanthanum oxide (La₂O₃) and tantalum pentoxide (Ta₂O₅) and aluminium oxide (Al₂O₃) were weighted to obtain the desired stoichiometry. For example, LLZTO was prepared with LiOH. H₂O, ZrO₂, La₂O₃ and Ta₂O₅ precursors with a molar ratio of 7.15:1.5:1.5:0.25. The samples were then mixed uniformly via planetary ball milling at 300 rpm for about 10 hours. The resulting mixture was then cold pressed into pellets, followed by annealing at a temperature of about 900° C. for about 12 hours in a muffle furnace. The as-prepared LLZTO pellets were then sandwiched in between two graphite heating elements and further densified via rapid heat treatment at a temperature of about 1280° C. for about 10 seconds under an argon atmosphere. The densified LLZTO solid-state electrolytes were then removed from the rapid heating device and stored inside an argon-filled glove box.

### (b) Coating of a Metal-Based Layer on the Surface of the LLZTO Solid-State Electrolytes Prepared in Example 1(a)

The garnet-type solid-state electrolytes prepared in Example 1(a) were coated with a layer of metal-based material comprising at least one metallic element selected from the groups 14 and 15 elements and at least one second metallic element via two different methods. For example, the metallic element selected from the groups 14 and 15 elements can react with lithium to form a Li-conductive compound, and the second metallic element can help to adjust the melting and boiling point of the metal alloy to keep the alloy in its liquid form during the heating process. In some examples, the metal alloy is further doped with bismuth.

The surface of the LLZTO solid-state electrolytes prepared in Example 1(a) was coated with different metal-based materials. Different mixture of metal powder precursors corresponding to the desired stoichiometry of AgSn, CoSn₆, LaSn₂, MnSn, Ni₂Sn, AgSb, CoSb, CuSb or AgSnₓBi₁₋ₓ (with x=1, 0.8, 0.6, 0.4 and 0) were prepared by weighting the corresponding elemental metal powders and uniformly mixing the powders using either a mortar and pestle or a ball milling method. To coat a metal-based material on a garnet-type solid-state electrolyte surface via the melt-quenching method, the garnet-type solid-state electrolyte pellet was rubbed over an excess amount of elemental metal powder spread on a weighting paper, during which the metal-based particles attach to the garnet surface via Van der Waals forces. Then, the free powders were blown off from the garnet surface using a jet of argon gas. The metal-based precursor treated LLZTO pellet was then sandwiched in between two graphite heating elements with the coated side facing upwards, and the temperature was rapidly increased to about 1100° C. to melt down the metal precursor and allow the liquid metal to fully spread across the LLZTO surface. A uniform metal-based coating was obtained by rapidly quenching the sample at a cooling rate of about 1×10³° C. min⁻¹.

LLZTO powders coated with a metal-based material were also prepared by mixing the metal precursor powders with the LLZTO powder in a weight ratio of about 1:40, followed by the melt-quenching method of the example.

### Example 2—Characterization of the LLZTO Solid-State Electrolytes Coated with a Layer of Metal-Based Material Prepared in Example 1(b)

The LLZTO solid-state electrolytes coated with a layer of metal-based material prepared in Example 1(b) were characterized by X-ray diffraction (XRD), X-ray photoelectron spectroscopy (XPS), scanning electron microscopy (SEM) and scanning transmission electron microscopy (STEM).

### (a) X-Ray Diffraction (XRD)

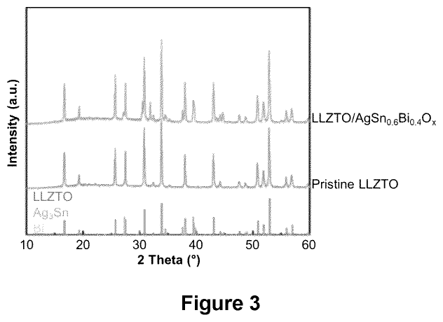

The crystal phases and purity of the LLZTO solid-state electrolytes coated with a layer of metal-based material prepared in Example 1(b) were studied by XRD. As it will be discussed later, the coating layer can also contain metal oxides (e.g. SnO/SnO₂ and Bi₂O₃) and therefore the overall coating composition is formulated as AgSn_{1-y}Bi_{y}Oₓ (0≤y≤1, 0≤x≤3) hereafter. XRD measurements were performed using a Rigaku MiniFlex X-ray diffractometer and carried out with 20 scanned from 10° to 60° at a scan rate of 1.5° min-1. XRD characterizations were conducted on the densified pristine LLZTO and the AgSn_{0.6}Bi_{0.4}Oₓ coated LLZTO solid-state electrolytes to confirm the existence of the AgSn_{0.6}Bi_{0.4}Oₓ coating layer on the LLZTO surface, and the resultant spectra are shown in FIG. 3. The diffraction peaks of the pristine LLZTO substantially to the characteristic peaks of cubic phase LLZTO. Compared to the XRD spectrum of the pristine LLZTO, several minor peaks corresponding to Ag, Ag₃Sn alloy, and Sn—Bi alloy can be observed on the XRD spectrum of the AgSn_{0.6}Bi_{0.4}Oₓ coated LLZTO solid-state electrolyte, indicative of the presence of a composite of different metal-based materials on the surface of the LLZTO.

### (b) X-Ray Photoelectron Spectroscopy (XPS)

The chemical composition of the LLZTO solid-state electrolytes coated with a layer of metal-based material prepared in Example 1(b) was studied by XPS (Kratos Axis Ultra DLD). The AgSn_{0.6}Bi_{0.4}Oₓ coated LLZTO solid-state electrolyte was loaded into a sealed capsule filled with argon to ensure an air-free transfer into the XPS chamber.

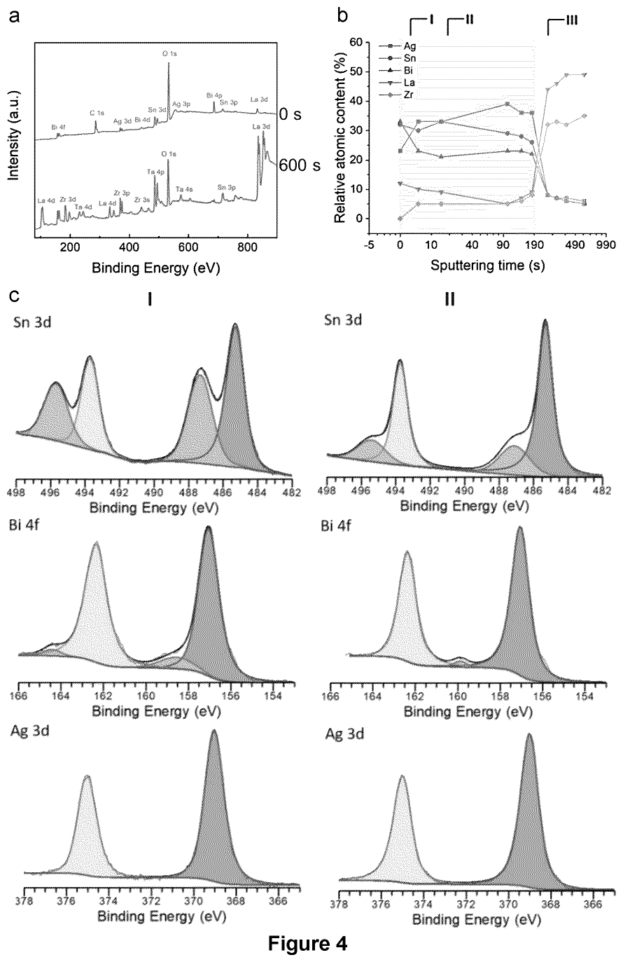

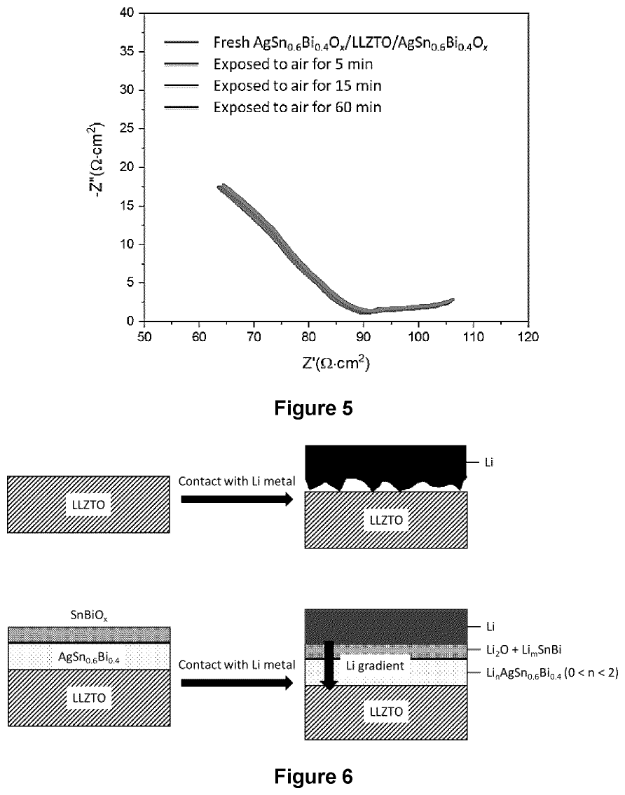

XPS characterizations were carried out to study the composition and thickness of the alloy coating. FIG. 4(a) shows an XPS survey spectrum of the AgSn_{0.6}Bi_{0.4}Oₓ coated LLZTO solid-state electrolyte before and after a time of argon ion sputtering equal to 600 seconds.

The XPS spectrum taken on the outer surface of the AgSn_{0.6}Bi_{0.4}Oₓ coated LLZTO solid-state electrolyte exhibits peaks indexed to Ag, Bi, Sn, C, and O. The presence of carbon may be a result of a very thin layer of hydrocarbons adsorbed on the sample, while the oxygen may originate from the oxidation of the surface of the metal alloy. It should be noted that no apparent peaks of Zr, La, and Ta are observed from the spectrum, implying that the LLZTO surface is covered uniformly by the metal alloy after the surface modification by the melt-quenching method. FIG. 4(b) displays XPS deconvoluted composition profiles for Ag, Sn, Bi, La and Zr at different argon ion sputtering times of the surface of the AgSn_{0.6}Bi_{0.4}Oₓ coated LLZTO solid-state electrolyte. FIG. 4(b) indicates that the surface of the AgSn_{0.6}Bi_{0.4}Oₓ coated LLZTO solid-state electrolyte (region I; FIG. 4(b) is covered by a SnOₓ-rich layer with some residual of BiOₓ; this SnOₓ-rich layer is so called SnBiOₓ hereafter. The convoluted fine XPS spectra of Ag, Sn, and Bi in regions I and II were recorded to further study the coordination of each element (FIG. 4(c)). The Sn and Bi atoms in region I are partially bonded to oxygen and consequently their deconvoluted XPS peak split to two peaks corresponding to metallic Sn and tin oxide (SnOₓ), and metallic Bi and bismuth oxide (BiOₓ), respectively. The Ag atoms, however, substantially remain in their metallic states which may be attributed to their resistance to oxidation compared to Sn and Bi. The EIS measurement of AgSn_{0.6}Bi_{0.4}Oₓ/LLZTO/AgSn_{0.6}Bi_{0.4}Oₓ sample revealed that the interfacial resistance maintains unchanged after the electrolyte was exposed to the ambient atmosphere for about 60 min (FIG. 5), indicating that the presence of a substantially dense SnBiOₓ layer may be beneficial to protect the LLZTO from reacting with atmosphere (e.g. H₂O and CO₂). Both the SnBiOₓ and the AgSn_{0.6}Bi_{0.4} are reactive with lithium metal, which assists the wetting of the lithium metal on the LLZTO surface (FIG. 6), resulting in the elimination of interfacial resistance. The bulk of the alloy coating (region II) consists of Ag, Bi, and Sn with a composition approximately equivalent to AgSn_{0.6}Bi_{0.4}, which is indicative of a successful coating of AgSn_{0.6}Bi_{0.4} layer onto the surface of the LLZTO with a uniform distribution of each element. The deconvoluted fine spectrum of Sn and Bi in region II shows significant decrease of intensities for the peaks indexed to the metal oxide as compared to the corresponding peaks in region I, indicating much reduced oxygen content in region II. The amount of Zr abruptly increases after argon sputtering for about 200 seconds, signifying the full removal of the AgSn_{0.6}Bi_{0.4}Oₓ coating and the exposure of the LLZTO surface, which roughly corresponds to an 80 nm thick of AgSn_{0.6}Bi_{0.4}Oₓ coating layer.

### (c) Scanning Electron Microscopy (SEM)

The morphology of the LLZTO and AgSn_{0.6}Bi_{0.4}Oₓ coated LLZTO solid-state electrolytes prepared in Example 1(b) was studied by SEM (FEI Quanta 650).

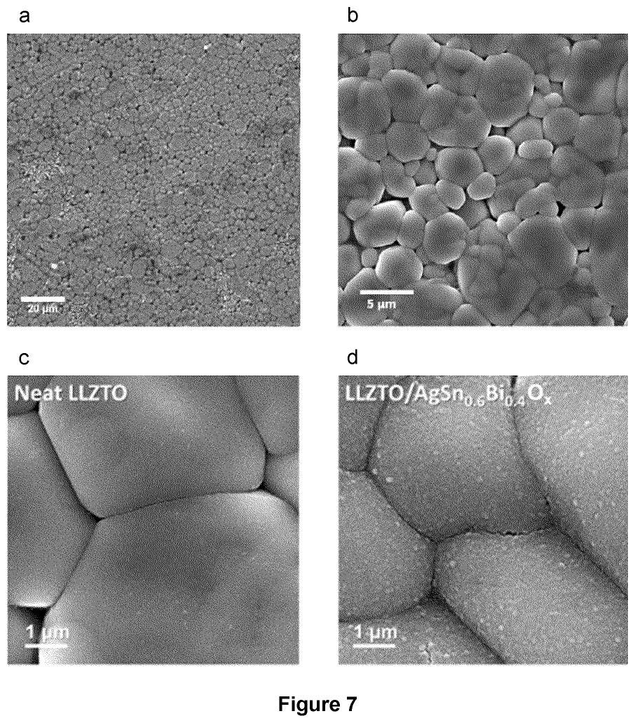

Measurements were carried out on the pristine LLZTO and the AgSn_{0.6}Bi_{0.4}Oₓ coated LLZTO solid-state electrolytes. SEM images of the pristine LLZTO and the AgSn_{0.6}Bi_{0.4}Oₓ coated LLZTO solid-state electrolytes are respectively presented in FIGS. 7(a) to 7(c) and 7(d). As can be seen in FIGS. 7(a) to 7(c), the conventional solid-state method followed by a densification step with a rapid heating method (FIG. 2(b)) results in about 60% densification of LLZTO. The pristine LLZTO solid-state electrolyte has a clean and smooth surface consisting of interconnected LLZTO grains with well-defined grain boundaries. As can be seen in FIG. 7(d), when a AgSn_{0.6}Bi_{0.4}Oₓ layer is coated on the surface of the LLZTO, the surface roughness increases, which may be ascribed to the surface being covered by the layer of AgSn_{0.6}Bi_{0.4}Oₓ.

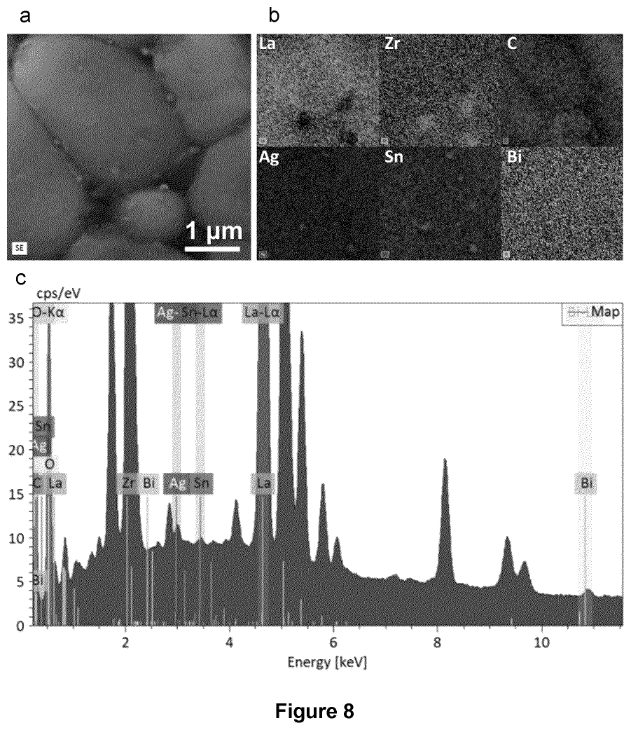

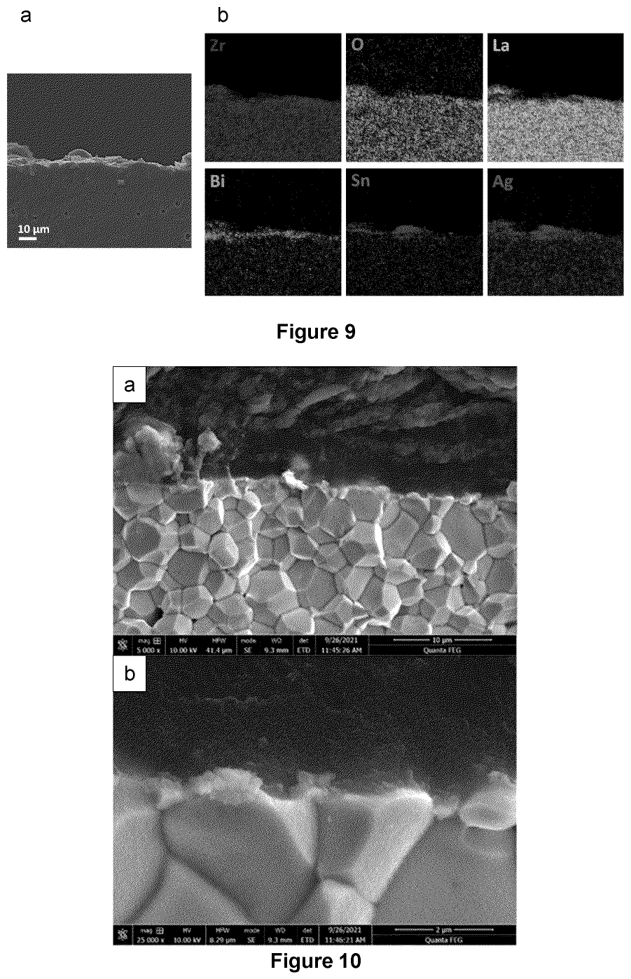

This was further demonstrated by the elemental mapping obtained by scanning electron microscopy-energy dispersive X-ray spectrometry (SEM-EDS) (FIGS. 8 and 9). FIGS. 8 and 9 show elemental mapping images obtained by EDS for the AgSn_{0.6}Bi_{0.4}Oₓ coated LLZTO solid-state electrolyte and a cross-section of the AgSn_{0.6}Bi_{0.4}Oₓ coated LLZTO solid-state electrolyte, respectively. FIGS. 8 and 9 show uniform Ag, Sn, and Bi signal distributions over the whole scanning area.

FIG. 10 presents in (a) a low and in (b) high magnification SEM images showing the interface between the AgSn_{0.6}Bi_{0.4}Oₓ coated LLZTO solid-state electrolyte and the lithium metal negative electrode.

### (d) Scanning Transmission Electron Microscopy (STEM)

The AgSn_{0.6}Bi_{0.4}Oₓ coated LLZTO solid-state electrolyte prepared in Example 1(b) were further characterized by STEM (JEOL NEOARM) equipped with an aberration corrector and operated at 80 kV.

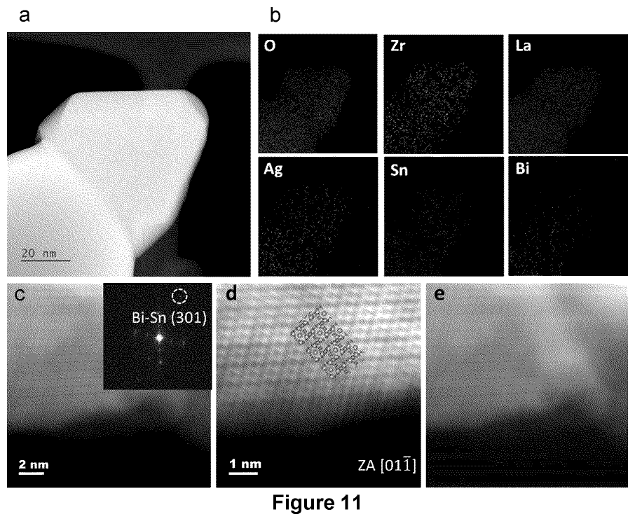

Atomic resolution STEM characterization was carried out on the AgSn_{0.6}Bi_{0.4}Oₓ coated LLZTO solid-state electrolyte. However, due to the limitation of the electron beam transmission, it was difficult to directly observe the morphology of the AgSn_{0.6}Bi_{0.4} coated LLZTO solid-state electrolyte pellet by STEM. Accordingly, AgSn_{0.6}Bi_{0.4}Oₓ coated LLZTO nanoparticles prepared in Example 1(b) were instead characterized by STEM because the general morphology of the AgSn_{0.6}Bi_{0.4}Oₓ coating layer remains substantially unchanged when substituting a pellet with nanoparticles despite variation of the coating thickness induced by the different surface areas between the two types of samples. FIG. 11(a) shows a low magnification high-angle annular dark field scanning transmission electron microscopy (HAADF-STEM) image of a AgSn_{0.6}Bi_{0.4}Oₓ coated LLZTO nanoparticle. The corresponding element mapping images taken on the same area (FIG. 11(b)) show a substantially uniform distribution of Ag, Sn, and Bi on the surface of the LLZTO nanoparticle, indicating that the AgSn_{0.6}Bi_{0.4}Oₓ alloy was uniformly coated on the surface of the LLZTO nanoparticle. FIG. 11(c) shows an atomic resolution STEM image obtained to show the detailed morphology of the AgSn_{0.6}Bi_{0.4}Oₓ coated LLZTO nanoparticle. The atomic arrangement depicts two different types of lattice structures overlapping with each other. The fast Fourier transformation (FFT) was carried out on the image, and results show patterns corresponding to LLZTO and to the Sn_{0.95}Bi_{0.05} alloy whose XRD diffraction patterns are not detectable apparently due to its very thin layer on the LLZTO surface. The LLZTO has a [011̅] zone axis, and the atomic arrangement substantially corresponds with the model cubic LLZO structure (FIG. 11(d)). The LLZTO and the metal alloy phases were further separated in the image by processing their corresponding FFT patterns. The LLZTO phase is represented by the yellow false color while the metal alloy phase is color with blue (FIG. 11(e)). The metal alloy phase is found to be in the intimate contact with LLZTO phase near the surface of the LLZTO particle, which is consistent with observations obtained by SEM and XPS.

### Example 3-Electrochemical Properties of the Garnet-Type Solid-State Electrolytes Prepared in Example 1(b)

### (a) Symmetric Cell Configurations

Symmetric cells were assembled to evaluate the interfacial stability between lithium metal and the LLZTO and coated LLZTO solid-state electrolytes. Two polished lithium disks with a diameter of 6 mm and thickness of 200 μm were used as both working and counter electrodes. The LLZTO solid-state electrolytes or coated LLZTO solid-state electrolytes were sandwiched in between the two lithium disks. The average thickness of the LLZTO solid-state electrolytes or the coated LLZTO solid-state electrolyte was of about 800 μm and the diameter of about 8 mm. All cells were assembled in 2032-type coin cell casings inside an argon-filled glove box with water and oxygen contents lower than about 0.1 ppm.

### (b) Electrochemical Cell Configurations

Solid-state full cell was also assembled using a commercially available LiFePO₄ (LFP) or LiNi_{0.8}Mn_{0.1}Co_{0.1}O₂(NMC 811) as the electrochemically active material of the positive electrode. The NMC 811 powder was first dried under vacuum at a temperature of about 200° C. overnight. To prepare the composite positive electrodes, polyacrylonitrile (PAN, Mw=150,000, Sigma-Aldrich) blended with succinonitrile (99%, Sigma-Aldrich) plasticizer was used as a lithium ion conducting component to provide a high lithium ion conductivity and stable operation to the electrochemical cell. The LFP or NMC 811 powder was then mixed with Super P™ conductive carbon, PAN, lithium bis(trifluoromethanesulfonyl)imide (LiTFSI) and succinonitrile at a weight ratio of 64.5:10:10:2:13.5 in N-methyl-2-pyrrolidone (NMP) solvent under constant stirring for about 24 hours to form a uniform slurry. The positive electrode slurry thus obtained was then cast onto the surface of an aluminum film using a doctor blade and then dried under vacuum at a temperature of about 60° C. overnight to obtain a solid positive electrode film. Disks with a diameter of 6 mm and a typical mass loading of 5 mg cm⁻² were then cut from the positive electrode thus obtained and used without any further modification. The LLZTO electrolyte for the solid-state electrochemical cell was coated on one side with a layer of metal-based material on which a polished lithium metal disk with a diameter of about 6 mm and a thickness of about 200 μm was stacked. To reduce the interfacial resistance at the interface of solid-sate electrolyte and the LFP or NMC 811 positive electrode, the surface the LLZTO solid-state electrolytes or coated LLZTO solid-state electrolytes was coated with a thin layer of polymer consisting of 5 wt. % of LiTFSI/succinonitrile (5 wt. %/95 wt. %) on the surface of the LLZTO solid-state electrolytes or coated LLZTO solid-state electrolytes facing towards the NMC 811 positive electrode. All the above-mentioned components were assembled in a 2032-type coin cell casing, and the cell was rested for about 24 hours before conducting the electrochemical measurements.

### (c) Electrochemical Impedance Spectroscopy (EIS)

The interfacial resistance between the coated LLZTO and the lithium metal was measured by EIS using an electrochemical workstation (Biologic VMP-300). An amplitude of 20 mV was used for the EIS measurements. The frequency for the EIS measurements ranged from 7×10⁶ Hz to 1 Hz.

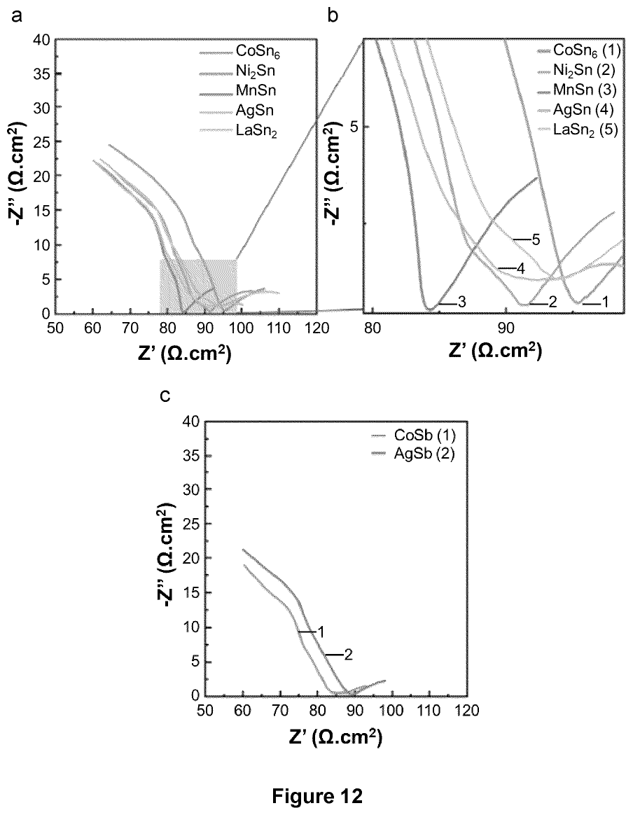

The metal-based coating materials were coated on the LLZTO surface with compositions corresponding to their most thermodynamically stable phases, and the interfacial resistance between the coated LLZTO and the lithium metal electrode were measured. The interfacial resistance was reduced significantly to less than 5 Ωcm⁻² with all types of metal-based coatings (FIG. 12(a)), which is in stark contrast to more than 1000 Ωcm⁻² reported from pristine LLZTO solid-state electrolyte. Without wishing to be bound by theory, the lithiophilic property of the metal-based coating materials may be among the most important reasons for the low interfacial resistance reported. Previous studies show interfacial resistance ranging from 10 Ωcm⁻² to 200 Ωcm⁻² by coating lithiophilic metals on garnet-type solid-state electrolytes (Luo, W., et al. “Reducing Interfacial Resistance between Garnet-Structured Solid-State Electrolyte and Li-Metal Anode by a Germanium Layer.” Advanced Materials 29 (2017): 1606042; Feng, W., et al. “Building an interfacial framework: Li/garnet interface stabilization through a Cu₆Sn₅ layer.” ACS Energy Letters 4.7 (2019): 1725-1731). The significantly decreased resistance obtained for the coated LLZTO may be the result of a substantially more uniform distribution of metal-based coating materials obtained using the melt-quenching process as compared to the conventional sputtering technique reported in the previous studies which often results in a non-uniform coating.

As shown in FIG. 12(b), the interfacial resistance of LLZTO coated with a layer of metal-based material with a metallic stoichiometric ratio of MnSn, CoSn₆ and AgSn is completely negated, while LLZTO coated with a layer of metal-based material with a metallic stoichiometric ratio of Ni₂Sn and LaSn₂ alloys still exhibit from about 1 Ωcm⁻² to about 5 Ωcm⁻² of interfacial resistance. The melting point of Ni₂Sn and LaSn₂ alloys are approximately at 1100° C. (Okamoto, H. “Supplemental Literature Review of Binary Phase Diagrams: B—Fe, Cr—Zr, Fe—Np, Fe—W, Fe—Zn, Ge—Ni, La—Sn, La—Ti, La—Zr, Li—Sn, Mn—S, and Nb—Re.” Journal of Phase Equilibria and Diffusion 37.5 (2016): 621-634; and Nash, P., and A. Nash. “The Ni—Sn (Nickel-Tin) system.” Bulletin of alloy phase diagrams 6.4 (1985): 350-359). As a result, an incomplete melting and/or wetting of the LLZTO surface by the Ni₂Sn and LaSn₂ alloy coating may be the reason for the interfacial resistance. Nevertheless, the coating of LLZTO with metal-based coating materials via a melt-quenching process was confirmed to be effective in reducing the interfacial resistance. To further demonstrate the effectiveness of the present coating strategy, LLZTO coated with antimony-based coating materials were prepared using the same method, and the interfacial resistance was also substantially eliminated according to the EIS measurements (FIG. 12(c)).

### (d) Galvanostatic Charge-Discharge Measurements and Electrochemical Behavior

The interfacial stability of the coated LLZTO electrolyte was evaluated by galvanostatic charge and discharge tests. The measurements were carried out on the symmetric cells prepared in Example 3 (a) with current densities ranging from 0.5 mA cm⁻² to 20 mA cm⁻² at a temperature of about 60° C., and a fixed capacity of 1, 0.5, and 0.1 mAh cm⁻² for each cycle.

The long-term interfacial stability of the coated LLZTO electrolyte was measured by cycling the symmetric cells at current densities of 0.5 mA cm⁻² and 1.2 mA cm⁻², respectively, for 2 000 hours.

The electrochemical performances of the electrochemical solid-state cells prepared in Example 3 (b) were evaluated by conducting galvanostatic charge and discharge tests at various C-rates using a battery tester (Neware).

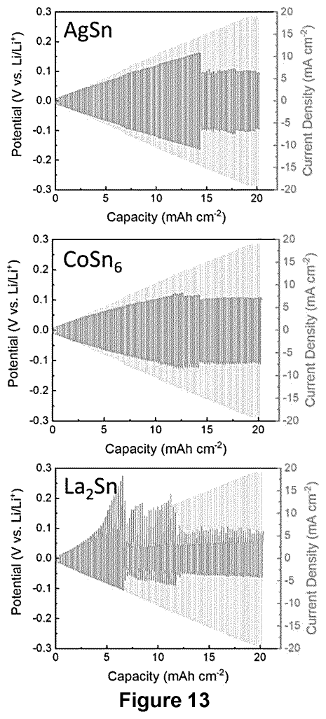

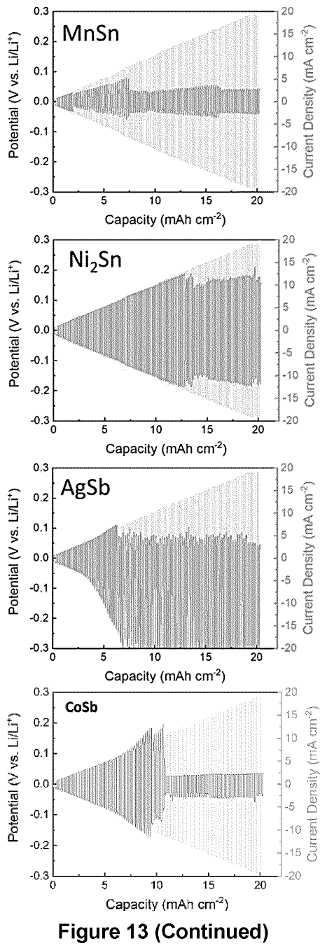

One of the major goals of developing LLZTO solid-state electrolytes is to prevent the formation of lithium dendrites during the lithium plating process. Although maintaining the interfacial contact is crucial for the smooth plating of lithium, lithium dendrites still form when the current density reach a limitation where the supply of lithium ions from the electrolyte is not sufficient for the plating of lithium (Brissot, C., et al. “Dendritic growth mechanisms in lithium/polymer cells.” Journal of power sources 81 (1999): 925-929; and Cheng, Xin-Bing, et al. “Toward safe lithium metal anode in rechargeable batteries: a review.” Chemical reviews 117.15 (2017): 10403-10473). As a result, despite significantly decreased interfacial resistances for the coated LLZTO solid-state electrolyte, short circuits are still induced along with the increasing current density of the symmetric cells as shown in FIG. 13. FIG. 13 shows rate performance experiment results for symmetric cells comprising LLZTO solid-state electrolytes coated with a layer of metal-based material based on Ag—Sn (Ag/Sn: 1/1), Co—Sn (Co/Sn: 1/6), La—Sn (La/Sn: 1/2), Mn—Sn (Mn/Sn: 1/1), Ni—Sn (Ni/Sn: 2/1), Ag—Sb (Ag/Sb: 1/1), and Co—Sb (Co/Sb: 1/1) tested at a temperature of 60° C. The best rate performance with a critical current density of 14.6 mA cm⁻² was observed with the interlayer based on Ag—Sn (Ag/Sn: 1/1); whereas the LLZTO electrolytes coated with La₂Sn, MnSn, CoSn₆, Ni₂Sn, AgSb, and CoSb show a critical current density of 7.0, 2.2, 12.8, 13.0, 6.2, and 9.8 mA cm⁻², respectively. The different critical current densities arising from different metal-based compositions may be a result of the different lithium diffusion rates as well as lithiophilicity in the metal-based coating layer. Despite providing an excellent interfacial contact for the LLZTO/Li interface, the CoSn₆, La₂Sn, MnSn, Ni₂Sn, AgSb, and CoSb alloys may possess a lower lithium diffusion rate that may lead to an insufficient supply of lithium during the plating process at high current densities and consequently to the formation of lithium dendrites and the short circuit of the electrochemical cell. It is therefore plausible that further modifications on improving the lithium diffusion can be made to the best performing coating material (i.e., Ag/Sn: 1/1) to enhance further its rate performance.

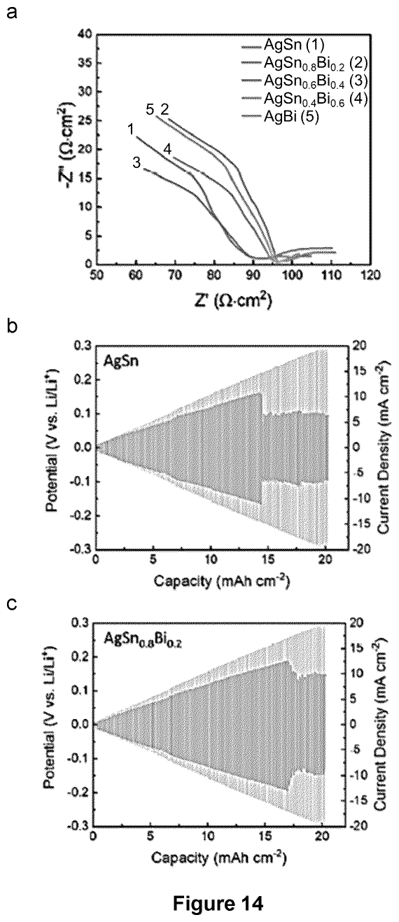

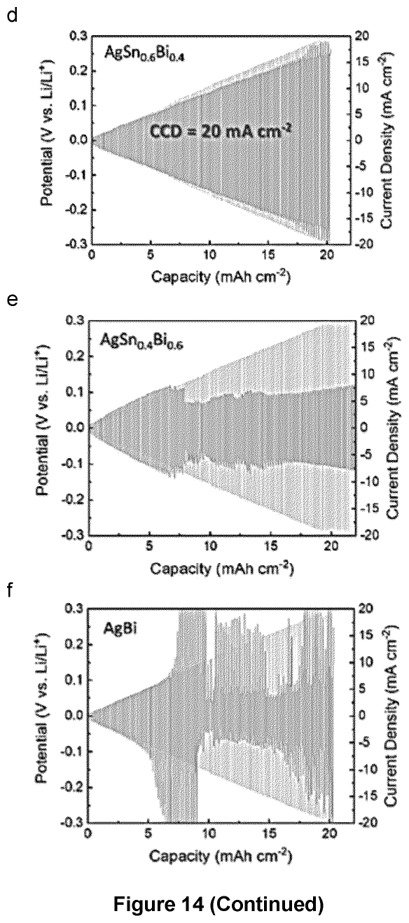

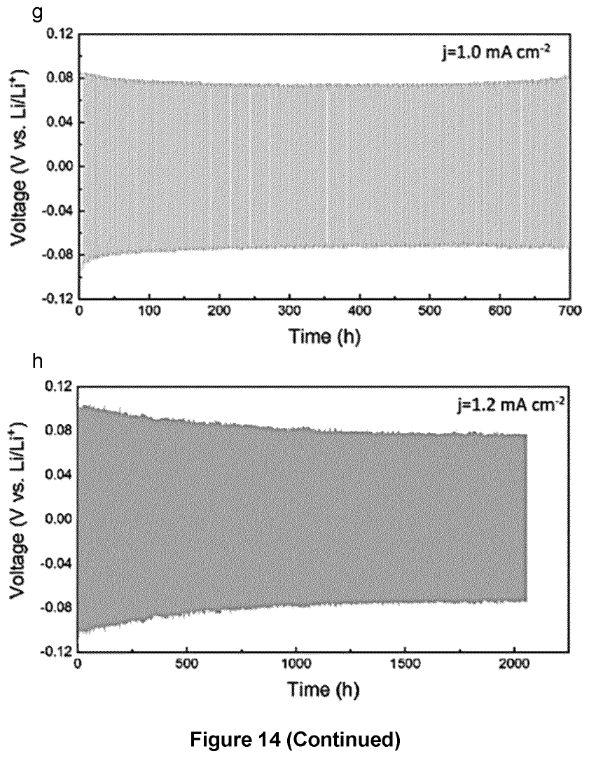

Modifications to increase lithium diffusion could also be made to the metal-based coating of the present description to further enhance their rate performances. It is reported that doping a metal alloy with heteroatoms can create vacancies (Shuai, J., et al. “Manipulating the Ge vacancies and Ge precipitates through Cr doping for realizing the high-performance GeTe thermoelectric material.” Small 16.13 (2020): 1906921; and Zhang, X., et al. “Vacancy manipulation for thermoelectric enhancements in GeTe alloys.” Journal of the American Chemical Society 140.46 (2018): 15883-15888) which in turn facilitate the vacancy-mediated lithium diffusion in the alloy (Cui, J., et al. “Rational exploration of conversion-alloying reaction based anodes for high-performance K-ion batteries.” ACS Materials Letters 3.4 (2021): 406-413). Bismuth atoms were doped into the Ag—Sn binary alloy to form a ternary alloy. AgSnₓBi₁₋ₓ-based material (with x=1, 0.8, 0.6, 0.4 and 0) were tested, and the interfacial resistances remained substantially negligible (FIG. 14(a)) despite changing compositions. However, a substantial increase in the critical current density was observed with increasing bismuth content at x=0.6 and 0.8 (FIG. 14(b) to (d)) which may be attributed to the increasing concentration of vacancies that facilitate the diffusion of lithium in the alloy. Nevertheless, when the bismuth content further increases, the concentration of vacancies decreases due to the presence of less tin than bismuth in the alloy, which in turn leads to a lower critical current density (FIGS. 14(e) and (f)).

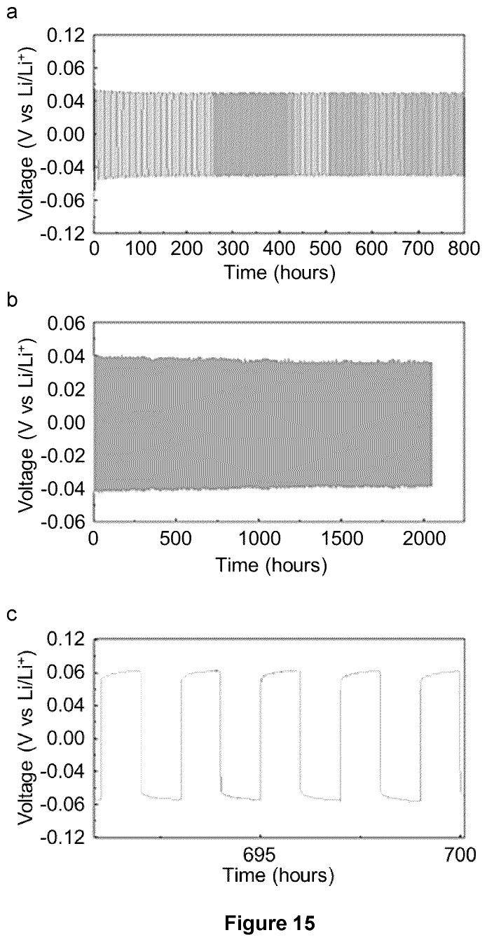

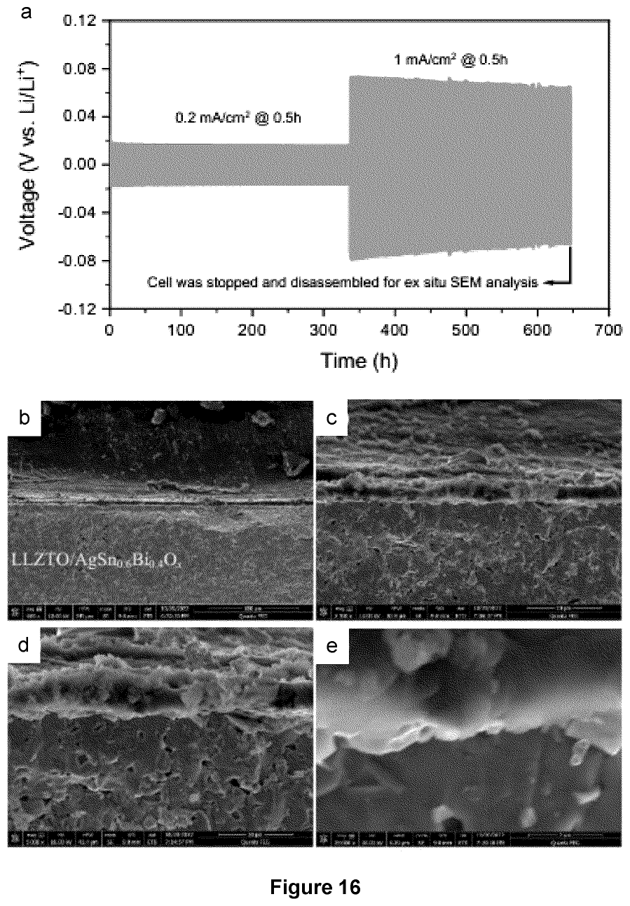

Overall, out of all the tested compositions, the AgSn_{0.6}Bi_{0.4}Oₓ coated LLZTO solid-state electrolyte exhibited the best rate performance with a critical current density of 20.0 mA cm⁻² at a temperature of 60° C. Such a high critical current density not only exceeded the requirement of stable operation of all-solid-state lithium metal batteries, but it is also the highest among all types of batteries with solid-state electrolytes. The long-term interfacial stability of a symmetric cell with a AgSn_{0.6}Bi_{0.4}Oₓ coated LLZTO solid-state electrolyte was also evaluated at room temperature to demonstrate the practical usefulness of the modified electrolytes in all-solid-state batteries. When tested at a current density of 0.5 mA cm⁻², with a capacity of 1 mAh cm⁻² (FIG. 15(a)) and 0.1 mAh cm⁻² (FIG. 15(b)), the symmetric cell showed a low lithium plating and stripping overpotential of about 35 mV due to the high ionic conductivity of the LLZTO (about 8×10⁻⁴ S cm⁻¹) and the negligible interfacial resistance between the AgSn_{0.6}Bi_{0.4}Oₓ coated LLZTO solid-state electrolyte and the lithium metal. Only a small increase in overpotential may be observed for the symmetric cell even after operating for more than 2000 hours, indicating the excellent stability of the AgSn_{0.6}Bi_{0.4}Oₓ coated LLZTO solid-state electrolyte against lithium metal. The interfacial stability of the AgSn_{0.6}Bi_{0.4}Oₓ coated LLZTO solid-state electrolyte with lithium metal was also tested at a high current density of 1.2 mA cm⁻² and 1 mA cm⁻² with areal capacities of 1 mAh cm⁻² (FIGS. 14(g) and 15(c)) and 0.1 mAh cm⁻² (FIG. 14(h)), respectively. In these symmetric cells, the overpotential gradually decreases initially, which may be ascribed to the activation of the interface at the high current density. The overpotential stabilizes over time to about 73-78 mV for more than 700 hours (at 1 mA cm-2/1 mAh cm⁻²) and 2000 hours (at 1 mA cm⁻²/0.1 mAh cm⁻²). The results suggest that the thin layer of AgSn_{0.6}Bi_{0.4}Oₓ can fills the non-uniformity of the LLZTO surface, leading to a substantially more homogeneous current along the surface as well as a high Li⁺ conductivity at the LLZTO/lithium interface. The alloy formed between the AgSn_{0.6}Bi_{0.4}Oₓ layer and the lithium metal may limit the formation of the dendrite. To observe any morphology changes after extended cycling of lithium plating and stripping, SEM images were recorded at the cross section of lithium and LLZTO/AgSn_{0.6}Bi_{0.4}Oₓ in a symmetric cell that was disassembled after being cycled for about 650 hours (340 hours at 0.2 mA cm⁻²/0.1 mAh cm⁻², and 310 hours at 1 mA cm^{-2/0.5} mAh cm⁻²) (FIG. 16(a)). FIGS. 16(b) to 16(e) are SEM images showing that lithium was uniformly plated on the LLZTO/AgSn_{0.6}Bi_{0.4}Oₓ after 1000 cycles with no sign of lithium dendrite penetration into the LLZTO. The symmetric cell tests clearly indicate that the alloy coating on the surface of the LLZTO solid-state electrolyte can effectively suppress the formation of lithium dendrites and greatly enhance both the rate and cyclic stability of the solid-state electrolyte when coupled with a lithium metal electrode.

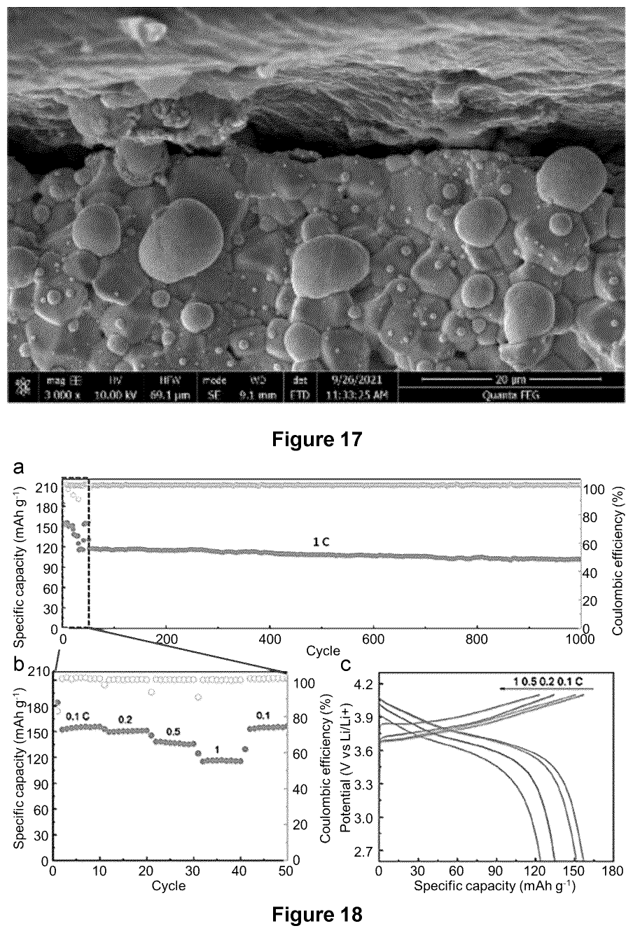

To demonstrate the practical usefulness of the AgSn_{0.6}Bi_{0.4}Oₓ coated LLZTO solid-state electrolyte, solid-state lithium metal electrochemical cells were assembled using NMC as the electrochemically active material of the positive electrode. The key to the stable operation of the electrochemical cell lies on the capability of the AgSn_{0.6}Bi_{0.4}Oₓ coated LLZTO solid-state electrolyte to suppress the dendritic lithium formation over extended cycles. Unlike the poor interfacial contact between LLZTO and lithium (FIG. 17), the AgSn_{0.6}Bi_{0.4}Oₓ facilitates an excellent interfacial contact between the LLZTO and the lithium metal negative electrode, which is confirmed by the cross-sectional SEM image (FIG. 10). Thanks to the excellent interfacial stability between the AgSn_{0.6}Bi_{0.4}Oₓ coated LLZTO solid-state electrolyte and the lithium metal negative electrode, the electrochemical cell delivered an excellent reversible lithium storage capacity of about 156 mAh g⁻¹ at 0.1 C with a cut-off voltage of 4.1 V (FIG. 18(a)). The electrochemical cell retained a capacity of about 116 mAh g⁻¹ even when tested at a high current density of 1 C at room temperature (FIG. 18(b)). The excellent rate performance of the electrochemical cell may be mainly ascribed to the reduced lithium plating/stripping overpotentials that result in a low polarization in the electrochemical cell (FIG. 18(c)). More importantly, the electrochemical cell delivered stable electrochemical performances for 1000 cycles at 1 C with an impressive capacity retention of about 86%, and no short circuit was observed thanks to the stable interface between the lithium metal and the solid-state electrolyte. Yet, the further increase of the energy density by higher positive electrode loadings (e.g. >5 mg cm⁻²) requires the adaption of a new polymer catholyte system having a high Li+ conductivity and oxidative potential.

### (e) Theoretical Calculations

All the theoretical calculations were based on the density functional theory (DFT) using a general gradient approximation with the Perdew-Burke-Ernzerhof (PBE) functionals (Perdew, John P., et al. “Generalized gradient approximation made simple.” Physical review letters 77.18 (1996): 3865-3868) and the projector augmented wave (PAW) pseudopotentials (Kresse, Georg, et al. “From ultrasoft pseudopotentials to the projector augmented-wave method.” Physical review b 59.3 (1999): 1758-1775). The Vienna Ab initio Simulation Package (VASP) (Hafner, Jürgen. “Ab-initio simulations of materials using VASP: Density-functional theory and beyond.” Journal of computational chemistry 29.13 (2008): 2044-2078) was used to perform the DFT calculations, and the convergence criteria was 10⁻⁶ eV and 10⁻² eV Å⁻¹ for the electron self-consistent calculations and Hellmann-Feynman forces, respectively. The kinetic cut-off energy for the plane wave was set at 600 eV. Supercells with 3×3×3 dimensions were built for the DFT calculations, and the reciprocal space was sampled using Monkhorst-Pack meshes with spacings smaller than 0.1 Å⁻¹ (Pack, James D., et al. “Special points for Brillouin-zone integrations”-a reply.” Physical Review B 16.4 (1977): 1748). The diffusion barriers were calculated using the climbed image nudged elastic band (CI-NEB) method with a force-based optimizer was adopted and the convergence criterion was set at 10⁻² eV Å⁻¹ (Henkelman, Graeme, et al. “A climbing image nudged elastic band method for finding saddle points and minimum energy paths.” The Journal of chemical physics 113.22 (2000): 9901-9904).

As mentioned above, the electrochemical performances showed that doping Bi atoms into the AgSn alloy lattice can significantly enhance the overall lithium diffusion kinetics. Accordingly, the enhancement mechanism was investigated. Without wishing to be bound by theory, the diffusion of lithium ions in the alloy may be mediated by the lithium vacancies. A higher vacancy concentration may bring about faster lithium diffusion rate, and the vacancy formation energy may be a good indicator for the concentration of the vacancy, the former of which can be calculated by DFT according to Equation 3, where Eᵣ denotes the vacancy formation energy, y is the amount of the lithium atoms that are removed from the unit cell to create vacancies, x is the stoichiometric ratio of Sn in the alloy, and E_{Li} is the DFT energy of a lithium atom.

$${E}_{f} = {E}_{L {i}_{2 - y} A g S {n}_{x} B {i}_{1 - x}} + y {E}_{L i} - {E}_{L {i}_{2} A g S {n}_{x} B {i}_{1 - x}} \qquad ( 3 )$$

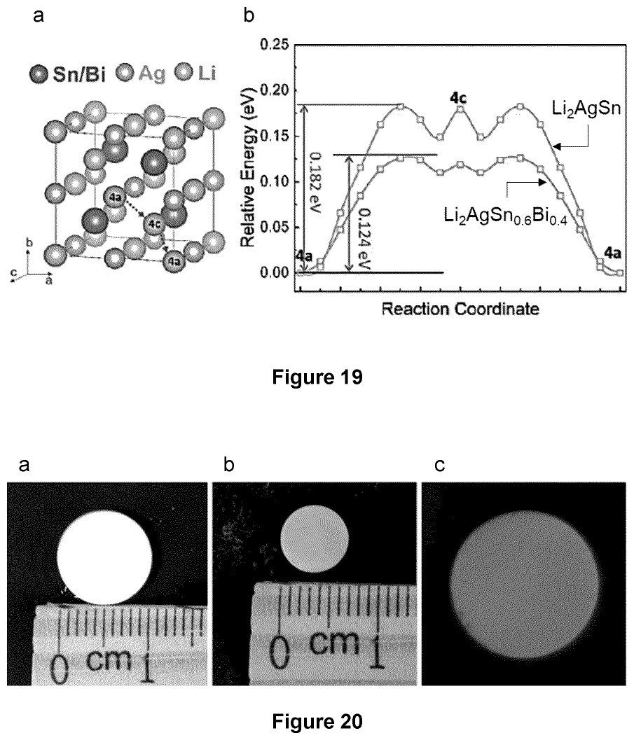

The vacancy formation energies of the Li₂AgSn and the Li₂AgSn_{0.6}Bi_{0.4} are calculated to be 1.07 eV and 0.97 eV, respectively. A lower vacancy formation energy of the Bi-doped alloy can indicate a possibly higher lithium vacancy concentration and the resultant faster lithium diffusion rates. Apart from the vacancy concentration, the diffusion barrier of lithium in the lattice of the alloy can also affect the lithium diffusion rate. As shown in FIG. 19(a), the lithium vacancy diffusion can follow a path of 4a→4c→4a, and the corresponding diffusion energy profile was calculated. FIG. 19(b) shows the comparison of the diffusion barriers between the Li₂AgSn and the Li₂AgSn_{0.6}Bi_{0.4}, and the diffusion barrier significantly reduced from 0.182 eV to 0.124 eV when Bi atoms are doped into the alloy. Therefore, the enhanced rate performance obtained with Bi-doped alloys may be the result of combining a higher concentration of lithium vacancy with a lower diffusion barrier.

### Example 4—Synthesis of Metal Alloy-Coated of Garnet-Type Solid-State Electrolytes

### (a) Coating a Layer of a Metal-Based Material on the Surface of a Garnet-Type Solid-State Electrolyte Prepared in Example 1(a)

The surface of the densified garnet-type solid-state electrolytes prepared in Example 1(a) was coated with various metal-based coating materials via the melt-quenching method. The metal powder precursors used for the garnet coating include aluminum (Al), tin (Sn), antimony (Sb), bismuth (Bi), and copper (Cu). For binary metal alloy coating, the desired ratio of two metal powders were mixed uniformly by planetary ball-milling at 300 rpm for 2 h in isopropanol followed by evaporating the solvent in a vacuum oven for 2 hours. The metal powders were stored in an Ar-filled glove box to avoid oxidation. The densified garnet-type solid-state electrolyte pellets were dipped in an excess amount of metal powder precursors, during which the metal particles attach to the garnet surface via Van der Waals forces. Then, the free powders were blown off from the garnet surface using a jet of argon gas. The processed pellet was loaded in the rapid heating system and a rapid heating (temperature ranging from about 700° C. to about 1200° C.) was carried out for about 3 seconds at a temperature ramping rate of 3×10³° C. min⁻¹ for both the heating and the quenching steps, after which the coated pellet was quickly transferred into an argon-filled glove box.

### Example 5—Characterization of the Coated Garnet-Type Solid-State Electrolytes Prepared in Example 4(a)

The coated garnet-type solid-state electrolytes prepared in Example 4(a) were characterized by XRD, XPS, SEM, EDS, and electrochemical tests. Theoretical calculations were also obtained.

### (a) X-Ray Diffraction (XRD)

The phases of the garnet pellets and densified garnet-type solid-state electrolytes with and without metal-based coatings were characterized by XRD (Rigaku Miniflex 600).

### (b) X-Ray Photoelectron Spectroscopy (XPS)

The surface chemistry of the coated garnet-type solid-state electrolytes was studied by XPS (Kratos Axis Ultra DLD), and a set of chambers and a capsule was used to transfer air-sensitive samples from an argon-filled glove box to the XPS chamber to avoid any contamination from the ambient atmosphere. Hydrocarbons with a thickness of 1 nm was removed by argon ion sputtering prior to the XPS characterization.

### (c) Scanning Electron Microscopy (SEM) and Energy Dispersive X-Ray Spectroscopy (EDS)

The morphology of the garnet pellets and densified garnet-type solid-state electrolytes with and without metal-based coatings was characterized by SEM (FEI Quanta 650). For the grain size measurement, the surface of the garnet-type solid-state electrolyte pellets was polished using a 1200 grit sandpaper followed by a thermal etching at a temperature of 1100° C. to expose the grain boundaries.

EDS elemental mapping was used to characterize chemical composition and morphology of the surface coating, and the samples were transferred into the SEM chamber from the argon-filled glove box using an air-protective transfer protocol by which the exposure of samples to air was nearly completely prevented.

### (d) Electrochemical Tests

Unless otherwise specified, the thickness of the garnet solid-state electrolyte pellets for all electrochemical tests was fixed at about 800 μm. To measure the Li⁺ conductivity, a solid-state electrolyte pellet was sandwiched between two blocking electrodes, and the Li⁺-conducting resistance of the electrolyte was measured by EIS (Biologic electrochemical workstation) with an amplitude of 20 mV and frequency range of from 7 MHz to 1 Hz. The Li⁺ conductivity was calculated according to Equation 4, where σ_{Li+} is the Lit conductivity, l and A represents the thickness and area of the solid-state electrolyte pellet, respectively. R is the Li⁺ conducting resistance measured from the EIS.

$${σ}_{{Li}^{+}} = \frac{l}{R A} \qquad ( 4 )$$

To measure the Li⁺ transference number, a symmetric cell with two lithium disks as working and counter electrodes was assembled. A bias of 10 mV was applied to the cell, and Nyquist plots before and after applying the bias were recorded to measure the change of resistance. The Li⁺ transference number was calculated based on Equation 5, where t_{Li+} denotes the Li⁺ transference number, l₀ and lₛ are the current responses to the bias at initial and steady states, respectively (Zugmann, Sandra, et al. “Measurement of transference numbers for lithium-ion electrolytes via four different methods, a comparative study.” Electrochimica Acta 56.11 (2011): 3926-3933). ΔV represents the amplitude of the bias, R₀ and Rₛ are the interfacial resistance between the lithium metal electrodes and the garnet-type solid-state electrolytes at initial and steady states, respectively, obtained from the Nyquist plots.

$${t}_{{Li}^{+}} = \frac{{I}_{s} ( Δ V - {I}_{0} {R}_{0} )}{{I}_{0} ( Δ V - {I}_{s} {R}_{s} )} \qquad ( 5 )$$

The interfacial stability between the lithium metal electrodes and the garnet-type solid-state electrolytes was evaluated with the same symmetric cell setup as that for the measurement of the Lit transference number. A constant current was applied to the symmetric cell to induce the lithium plating/stripping and the corresponding overpotential was recorded as a function of time.

To evaluate the electrochemical performance of all-solid-state Li metal batteries consisting of the surface-modified garnet-type solid-state electrolytes, lithium metal negative electrodes and composite positive electrodes comprising a commercially available LiFePO₄ or NMC 811 as the electrochemically active material. To prepare the composite positive electrodes, PAN blended with succinonitrile plasticizer was used as Lit-conducting component, which has been shown to provide a high Li⁺ conductivity and stable operation to the electrochemical cell (Lu, Ziheng, et al. “Modulating Nanoinhomogeneity at Electrode-Solid Electrolyte Interfaces for Dendrite-Proof Solid-State Batteries and Long-Life Memristors.” Advanced Energy Materials 11.16 (2021): 2003811; and Tran, Hoai Khang, et al. “Composite Polymer Electrolytes Based on PVA/PAN for All-Solid-State Lithium Metal Batteries Operated at Room Temperature.” ACS Applied Energy Materials 3.11 (2020): 11024-11035). The LFP or NMC powders were mixed with conductive carbon black, PAN, SN, and LiTFSI in a 64.5:10:10:2:13.5 weight ratio. The solid mixture was dispersed in anhydrous NMP to form a uniform slurry, which was then cast onto an aluminum foil and fully dried under vacuum at a temperature 60° C. to obtain a solid positive electrode film. Electrode disks with a mass loading of about 5 mg cm⁻² were then cut from the positive electrode-coated aluminum foil and used to assemble the all-solid-state Li metal batteries. To carry out the electrochemical cell assembly, one side of the garnet-type solid-state electrolyte pellet coated with a layer of metal-based material as described in Example 4(a), while the other side was coated with a thin solid interfacial organic layer (5 wt. % LiTFSI in SN) to increase the interfacial contact between the positive electrode and the garnet-type solid-state electrolyte. The garnet-type solid-state electrolyte pellet was then sandwiched between the positive electrode and a lithium metal negative electrode and assembled in 2032-type coin cell casings for electrochemical testing. All electrochemical tests were carried out on a Neware battery testing system via galvanostatic charge and discharge at different current densities.

To compare the electrochemical performances, conventional electrochemical cells with liquid electrolytes were also prepared using LFP or NMC 811 as positive electrochemically active material. The positive electrodes were prepared by a similar slurry casting method while the composition of the positive electrode was changed to 80 wt. % LFP or NMC 811, 10 wt. % conductive carbon black, and 10 wt. % polyvinylidene fluoride (PVDF) binder. The cells comprising liquid electrolytes were assembled with Celgard™ 2400 membrane separators impregnated with a 1 M LiPF₆ solution in a non-aqueous solvent mixture of ethylene carbonate/ethylmethyl carbonate (EC/EMC) (1:1 by volume) as a liquid electrolyte.

### (e) Simulations

All the simulations were conducted with the VASP (Hafner, Jürgen. “Ab-initio simulations of materials using VASP: Density-functional theory and beyond.” Journal of computational chemistry 29.13 (2008): 2044-2078) based on DFT under the general gradient approximation with the PBE functionals (Perdew, John P., et al. “Generalized gradient approximation made simple.” Physical review letters 77.18 (1996): 3865) and PAW pseudopotentials (Kresse, Georg, et al. “From ultrasoft pseudopotentials to the projector augmented-wave method.” Physical review b 59.3 (1999): 1758). The DFT calculations were considered converged when the residual of electron self-consistent calculations and Hellmann-Feynman forces were smaller than 10⁻⁶ eV and 10⁻² eV Å⁻¹, respectively. The plane waves were cut off at kinetic energy of 600 eV, and Monkhorst-Pack meshes with spacings smaller than 0.1 Å⁻¹ was used to sample the reciprocal space for all static calculations (Pack, James D., et al. “Special points for Brillouin-zone integrations”-a reply.” Physical Review B 16.4 (1977): 1748). To simulate the interactions between the metal atoms and the garnet surface at finite temperature, ab initio molecular dynamics (AIMD) were carried out following the same parameters as the static DFT calculations except that only the gamma point was sampled for the calculation.

### Example 6—Result and Discussion

The low porosity and high chemical uniformity are essential for the garnet-type solid-state electrolyte to facilitate uniform lithium plating and stripping and suppress dendrite formation in Li metal batteries. Conventional methods such as sintering in a furnace are not only costly and time-consuming, but also fail to yield high-quality garnet-type solid-state electrolytes due to the inevitable loss of lithium at high temperature. Rapid densification method, on the other hand, is often preferred mainly because the above-mentioned loss of lithium can be minimized by shortening the sintering duration. To synthesize high-quality garnet solid-state electrolytes for later studies of its interfacial properties, a rapid heating approach was developed based on a high-temperature sintering method (Wang, Chengwei, et al. “A general method to synthesize and sinter bulk ceramics in seconds.” Science 368.6490 (2020): 521-526), enabling the preparation of densified garnet solid-state electrolytes within seconds (FIG. 2).

During the densification step (about 10 seconds at a temperature of about 1280° C.), the white-colored LLZTO pellet with an original diameter of 10 mm (FIG. 20(a)) was quickly transformed into a greyish garnet-type solid-state electrolyte with a diameter of about 7 mm. Comparison of luminescence images of these two garnet-type solid-state electrolytes shows that the densified garnet sample emits a deep blue light when exited by ultraviolet radiation with a wavelength of 254 nm while the garnet-type sample without densification by rapid heating completely absorbs the 254 nm ultraviolet light (FIG. 20(b)), indicating the high purity and low porosity the densified garnet-type solid-state electrolyte (Raukas, M., et al. “Ceramic phosphors for light conversion in LEDs.” ECS Journal of Solid State Science and Technology 2.2 (2012): R3168).

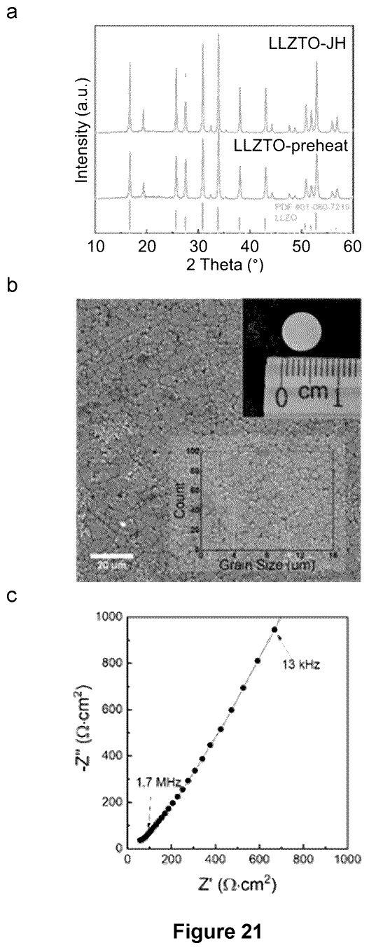

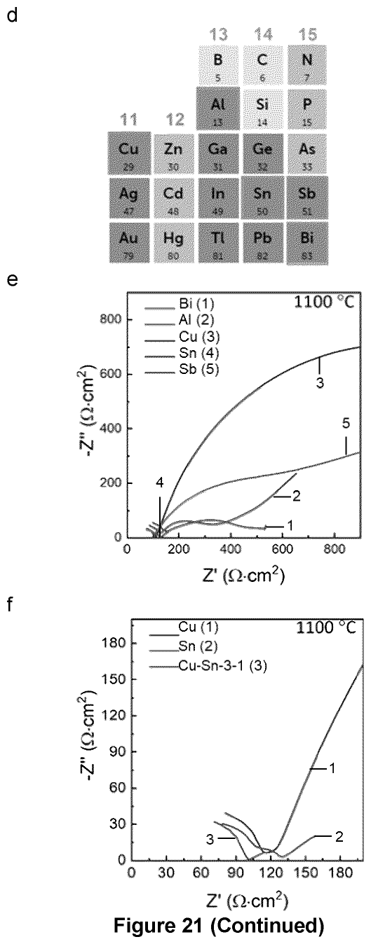

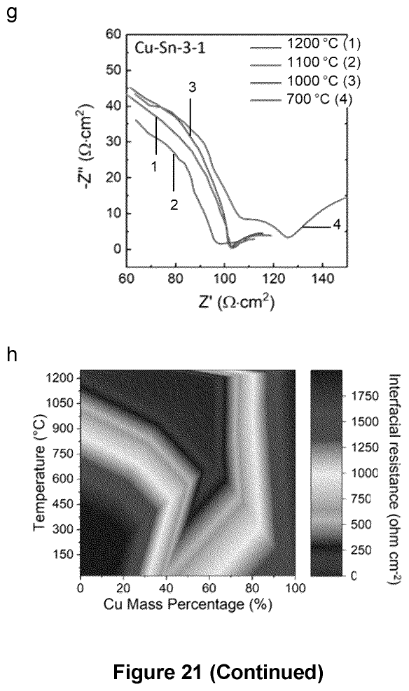

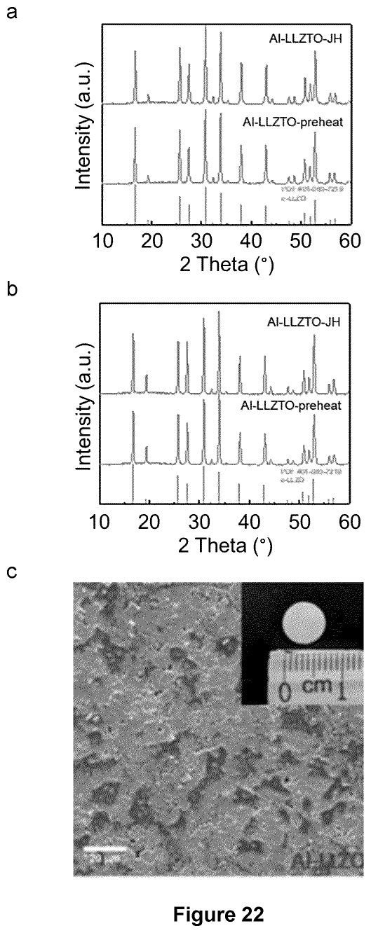

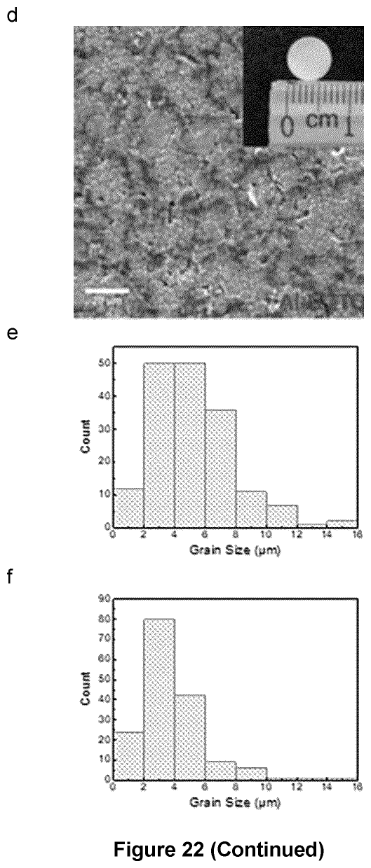

FIGS. 21(a), 22(a), and 22(b) respectively presents the XRD spectra obtained for LLZTO, Al-LLZO and Al-LLZTO solid-state electrolytes before and after densification by rapid heating, all of which show negligible impurities, and all the characteristic peaks substantially correspond with the standard XRD peaks of cubic phase garnet.

The rapid densification process prohibits the growth of grains in garnet-type solid-state electrolytes, resulting in a much smaller mean grain size of about 3.7 μm for the LLZTO (FIG. 21(b)), while a slight increase of grain size was observed on garnet-type samples with aluminum doping, for example, a grain size of about 5.2 μm and about 4.0 μm for Al-LLZO and Al-LLZTO, respectively (FIGS. 22(c) to (f)). This may be due to the fusion of the grains facilitated by aluminum doping. Nonetheless, all the garnet-type solid-state electrolytes synthesized via the rapid heating method possess a substantially high purity and minimal porosity, which can regulate the uniform distribution of local current density and prohibit the formation and growth of lithium dendrites and benefit the stability of Li metal batteries. The LLZTO was thermally etched at a temperature of about 1100° C. for about 12 hours prior to the SEM characterization to expose the grain boundaries.

The ionic conductivity of the LLZTO, Al-LLZO and Al-LLZTO electrolytes were measured and the conductivity of the LLZTO electrolyte reached 8×10⁻⁴ S cm⁻¹ (FIG. 21(c)) at room temperature, which was the highest among three compositions of electrolytes. It is widely reported that Ta doping facilitates facile Lit conduction, and the high Li⁺ conductivity of the LLZTO electrolyte is in line with previous reports (Li, Yutao, et al. “Optimizing Li+ conductivity in a garnet framework.” Journal of Materials Chemistry 22.30 (2012): 15357-15361).

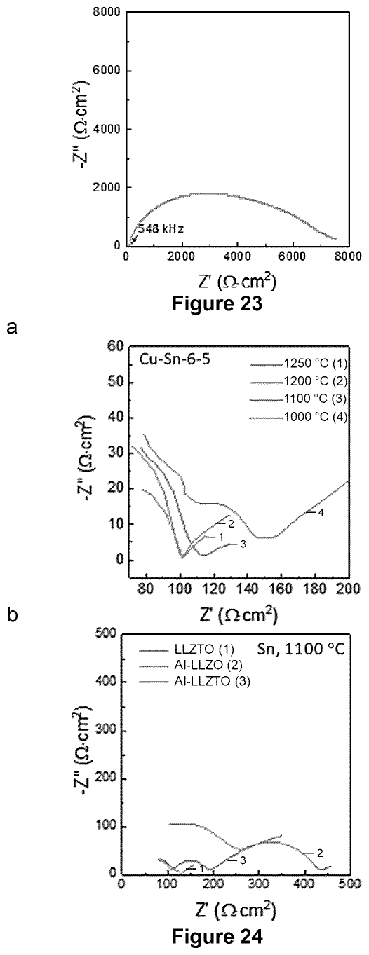

The pristine garnet electrolyte suffers from sluggish Lit transport through the electrolyte-lithium interface owing to the poor interfacial contact, which often brings about a high interfacial resistance (FIG. 23), making it practically impossible to be directly used in a Li metal battery. Aiming at fully resolving the interfacial issue, a series of Li⁺-conducting metals and their alloys were screened to find the best candidates that can eliminate the interfacial resistance upon operation of a Li metal battery. There are four general principles for the screening: (i) the cost of the metal needs to be reasonably low for practical application; (ii) the metal should form a thermodynamically stable metal alloy with Li at room temperature to facilitate Li⁺ conduction through an alloying-dealloying process at the electrolyte/lithium interface; (iii) the metal should possess low toxicity for humans and the environment; (iv) the metal should be in its liquid form at the processing temperature (i.e., a temperature of 1100° C.) to fully wet and spread across the garnet surface to form a uniform coating.

As shown in FIG. 21(d), five candidates (Al, Sn, Sb, Bi, and Cu) were identified. An ultra-thin coating layer based on a single or binary metal was coated onto the surface of LLZTO by the melt-quenching method using the rapid heating equipment (FIG. 2(a)). The EIS spectra of the LLZTO solid-state electrolytes modified with different metal-based coatings are shown in FIG. 21(e). The EIS results showed that the interfacial resistance was reduced significantly by coatings based on Al, Sn, Sb, and Bi, while Cu-based coating exhibits a negligible effect which may be due to the low solubility of Li in Cu. It is worth noting that the coated LLZTO solid-state electrolyte based on Sn possesses the smallest interfacial resistance (35 Ωcm⁻²) compared to those of LLZTO solid-state electrolytes coated with the other metals. The effect of Sn on reducing the interfacial resistance is heavily compromised when Al is doped into the garnet electrolyte (FIG. 24(b) due to the poor wetting of Sn on the Al-rich grain boundaries. Consequently, only Al-free LLZTO was studied later for the characterizations and electrochemical performances. To further reduce the interfacial resistance, different compositions of Sn—X binary alloy (X: Al, Cu, Bi, and Sb) were tested. Nonetheless, when the coated garnet-type solid-state electrolyte was coupled with lithium metal electrodes, a thermodynamically stable Li—Sn—X phase only forms with X=Cu according to the crystallographic database, consequently, only when a coating based on Sn—Cu (Cu/Sn=3) was deposited on the LLZTO surface, the interfacial resistance was substantially eliminated (FIG. 21(f)). It is believed that this is the first time that a surface coating on a garnet solid-state electrolyte can achieve a substantial elimination of the interfacial resistance. Although the elimination of the interfacial resistance is carried out at a heating temperature of 1100° C. with a Cu/Sn=3, it is hypothesized that there will be a range of temperature and composition within which the interfacial resistance can be eliminated. FIGS. 21(g) and 24(a) present the EIS spectra of a Cu—Sn-based coating material (Cu/Sn=3) coated on an LLZTO solid-state electrolyte prepared at a fixed composition but at different temperatures (EIS spectra for Cu—Sn-based coating material (Cu/Sn=6/5) are given in FIG. 24(a)). The interfacial resistances were reduced to zero only after the heating temperature reached above 1000° C. for a Cu—Sn-based coating material (Cu/Sn=3), which is because a relatively high temperature is a prerequisite to form such a Cu—Sn-based coating material (Fürtauer, S., et al. “The Cu—Sn phase diagram, Part I: new experimental results.” Intermetallics 34 (2013): 142-147). The effect of the composition of the Cu—Sn-based coating material was also studied, and the interfacial resistance as a function of both the temperature and the composition is shown in FIG. 21(h). The results show that there is a wide range of temperature (from about 1050° C. to about 1200° C.) and composition (6/5<Cu/Sn<corresponding to a Cu mass percentage of about 39% to about 62%) that can be used to reduce the interfacial resistance to zero, offering a substantially great robustness to this approach for practical applications. As it will be discussed later, the coating layer is covered with an ultra-thin layer of thin oxides (SnO/SnO₂) and therefore the overall coating composition is denoted as Cu_{z}Sn_{y}Oₓ (6/5<z/y<3) hereafter.

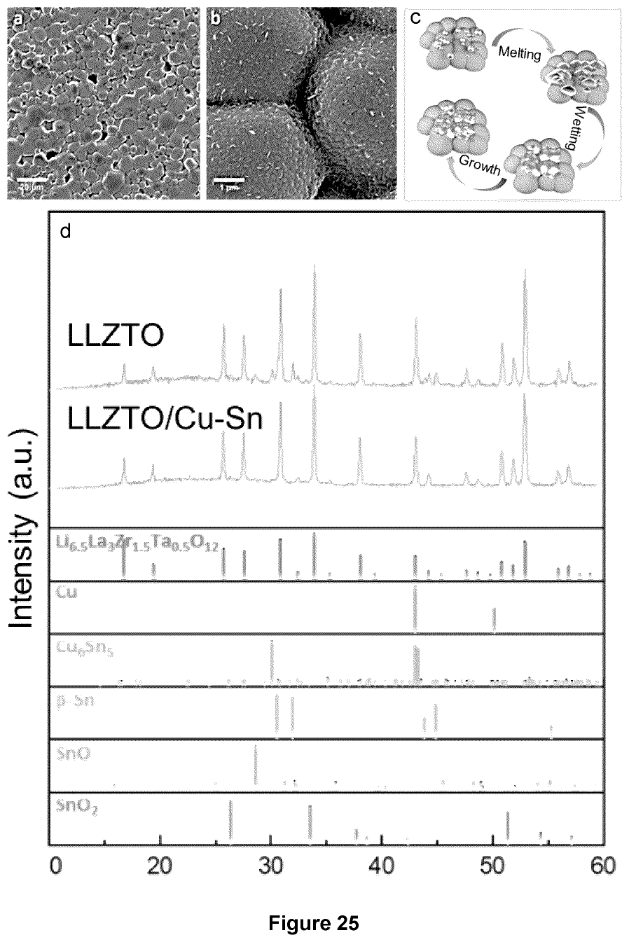

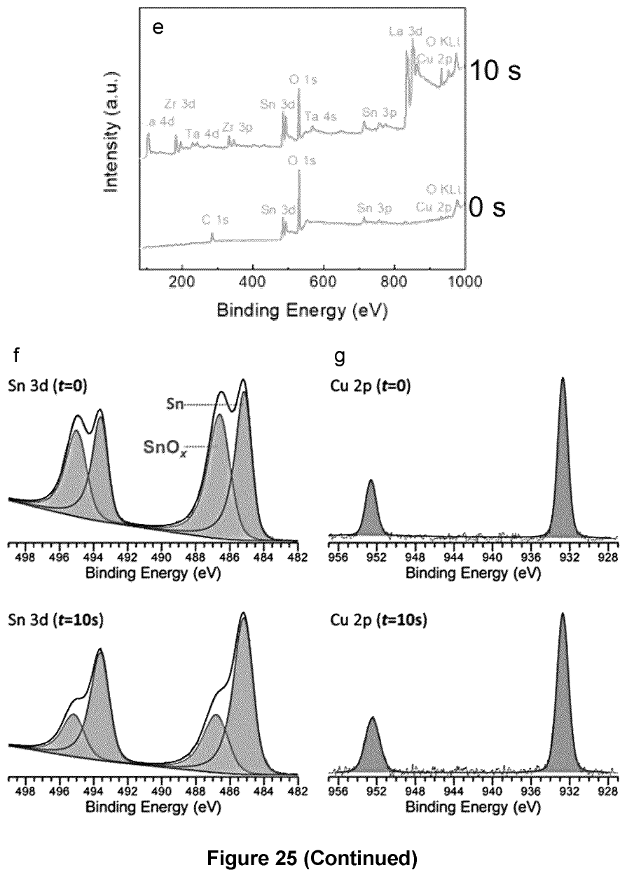

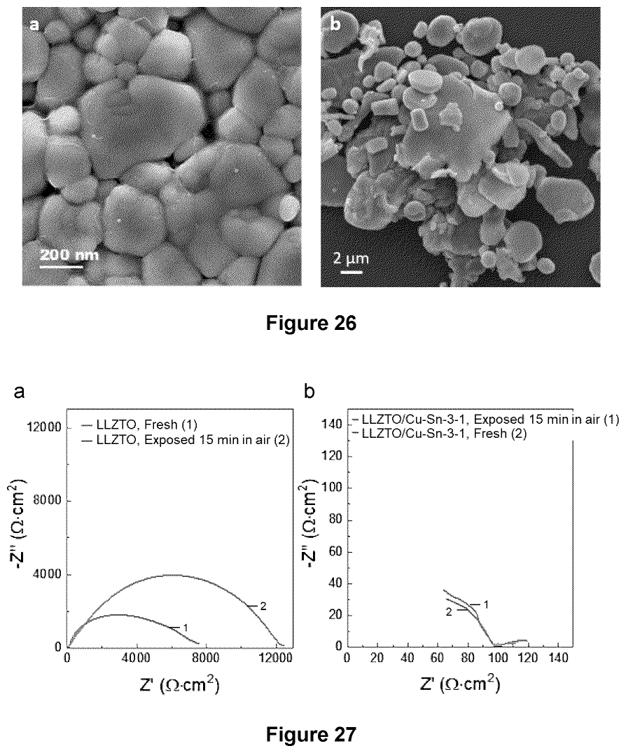

The morphology of the Cu_{z}Sn_{y}Oₓ surface coating was characterized by SEM as shown in FIGS. 25(a) and 25(b). The morphology of the LLZTO with Cu_{z}Sn_{y}Oₓ coating at low magnification (FIG. 25(a)) is nearly identical to that of the pristine LLZTO surface (FIG. 21(b)). The surface of the LLZTO with melt-quenching treatment is revealed to be covered by a layer of densely packed nano platelets when observing at a higher magnification (FIG. 25(b)), which is different from the smooth surface of the pristine LLZTO (FIG. 26(a)). As schematically illustrated in FIG. 25(c), it is proposed that the original micro-sized particles of the Cu—Sn powder (FIG. 26(b)) melt under the high temperature during the melt-quenching treatment. The Cu—Sn liquid has strong affinity to the LLZTO through the interaction of Li and O from LLZTO with Sn and Cu, respectively, resulting in its wetting and spreading across the whole LLZTO surface. Upon cooling down, Cu—Sn liquid readily transformed to solid Cu_{z}Sn_{y}Oₓ that substantially uniformly covered the LLZTO surface, and the morphology of nanoplatelet is ascribed to the growth of Cu_{z}Sn_{y}Oₓ crystals (Tian, Yanhong, et al. “Relationship between morphologies and orientations of Cu₆Sn₅ grains in Sn_{3.0}Ag_{0.5}Cu solder joints on different Cu pads.” Materials characterization 88 (2014): 58-68). To further identify the composition of the Cu_{z}Sn_{y}Oₓ coating, XRD and XPS characterizations were carried out on the Cu_{z}Sn_{y}Oₓ coated LLZTO. As shown in FIG. 25(d), compared with the pristine LLZTO, several characteristic diffraction peaks which can be assigned to the Cu₆Sn₅, B—Sn, Cu, SnO, and SnO₂ were identified in addition to the LLZTO peaks. The XPS spectrum (FIG. 25(e)) with a lateral resolution of about 100 μm (about 730 grains of LLZTO) recorded on the Cu₃SnOₓ coated LLZTO only presents major characteristic peaks corresponding to Sn, Cu and O, while peaks corresponding to the LLZTO are not detectable by the surface sensitive XPS technique, indicating that the LLZTO surface is fully covered by a substantially uniform layer of Cu₃SnOₓ coating. The Cu₃SnOₓ coating layer was later removed by sputtering for about 10 seconds corresponding to the removal of about 5 nm thick of surface coating layer, and new peaks indexed to the La, Zr, and Ta (Cheng, Lei, et al. “Garnet electrolyte surface degradation and recovery.” ACS Applied Energy Materials 1.12 (2018): 7244-7252; and Sharafi, Asma, et al. “Impact of air exposure and surface chemistry on Li—Li₇La₃Zr₂O₁₂ interfacial resistance.” Journal of Materials Chemistry A 5.26 (2017): 13475-13487) from the LLZTO emerged from the new XPS spectrum, which is a further indication of the presence of a thin and substantially uniform Cu₃SnOₓ coating on the LLZTO surface. According to the XPS survey spectrum, a peak corresponding to oxygen was detected in the coating layer (FIG. 25(e)), and the high-resolution spectra of Sn (FIG. 25(f)) and Cu (FIG. 25(g)) were further recorded to reveal the local coordination of oxygen. The oxygen was found to mainly bond to the Sn atoms that are positioned on the outer surface of the coating due to the inevitable oxidation of Sn upon contact with the atmosphere. In the present experiment, the inevitable exposure of Sn to the oxygen both during the alloy powder preparation and the melt-quenching step is responsible for the surface oxygen; the presence of oxygen molecules (i.e., oxygenated environment) has shown to improve the wettability, and hence the uniformity, of liquid metals with garnet substrates compared to those coatings obtained in an oxygen-lean atmosphere. Besides, such an oxide layer (SnO/SnO₂, hereafter denoted as SnOₓ) can be beneficial as it effectively shielded the garnet-type solid-state electrolyte and the underlying metal-based coating from ambient moisture. As shown in FIG. 27, the interfacial resistance of uncoated LLZTO doubled after ambient exposure for 15 minutes whereas it remained unchanged for the Cu₃SnOₓ coated LLZTO, indicating that the LLZTO surface has been intact after being exposed to the same ambient conditions. The composition profile of the Cu₃SnOₓ coated LLZTO is shown schematically in FIG. 25(h): a layer of a Cu₃SnOₓ which may comprise Cu₆Sn₅, Sn and Cu is substantially uniformly coated onto the LLZTO surface, while the very top of the coating layer is covered by a thin layer of tin oxide.

To further understand the mechanism for the formation of Cu—Sn-based coatings, first-principle calculations were conducted at both 0 K and finite temperature. One of the most critical factors determining the wetting property of liquid metal on a ceramic substrate is the contact angle, which can be derived from Equation 4 and 5, where

$${U}_{a d}^{m} ,$$

U_{LG}/2 and U_{SL} are the energy for m, ∞, and 1 layers of liquid metal to adsorb on the substrate, respectively, and cos e is the contact angle (Tian, Hong-Kang, et al. “Computational study of lithium nucleation tendency in Li₇La₃Zr₂O₁₂ (LLZO) and rational design of interlayer materials to prevent lithium dendrites.” Journal of Power Sources 392 (2018): 79-86; and Lu, Jin-You, et al. “The evolution in graphitic surface wettability with first-principles quantum simulations: the counterintuitive role of water.” Physical Chemistry Chemical Physics 20.35 (2018): 22636-22644).

$${U}_{a d}^{m} = \frac{{U}_{S L + m L} - {U}_{S L + ( m - 1 ) L} - {U}_{m L}}{{n}_{L}} \qquad ( 4 )$$

$$cos ( θ ) = \frac{{U}_{S {L}^{-}} {U}_{L G} / 2}{{U}_{L G} / 2} \qquad ( 5 )$$

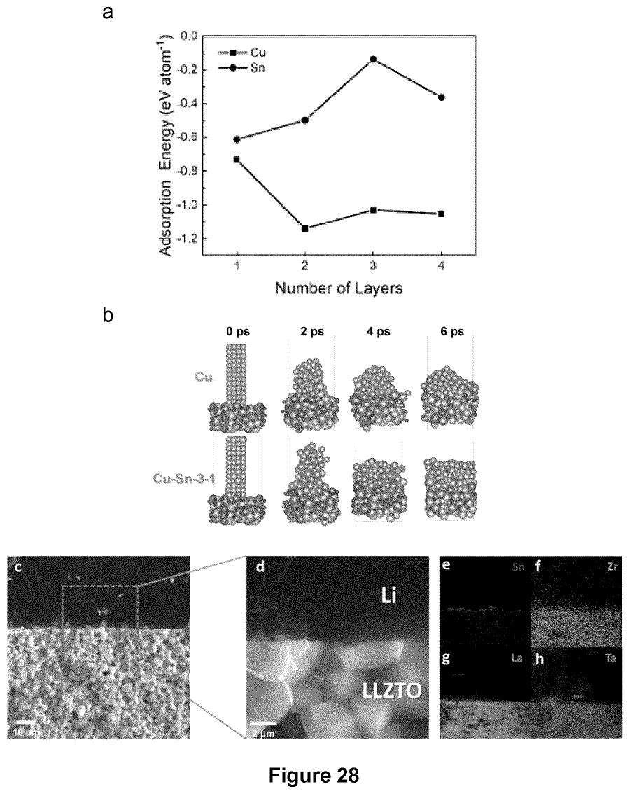

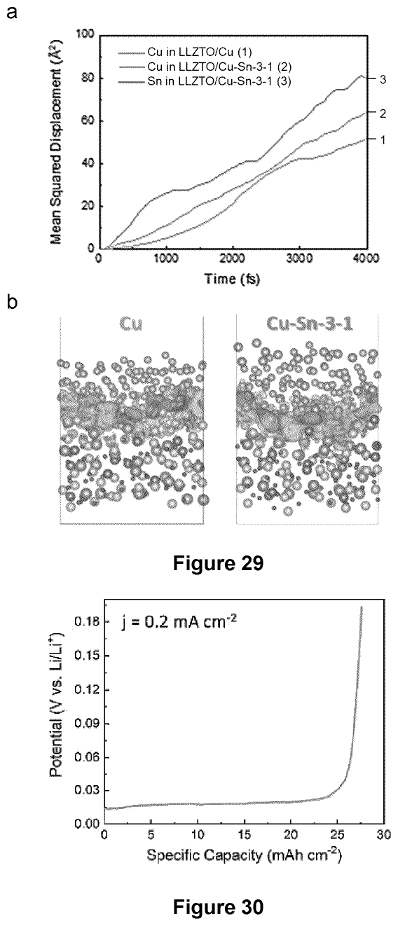

FIG. 28(a) summarizes the calculated adsorption energies as a function of the number of layers for Sn and Cu with contact angles of Cu and Sn on the LLZTO surface calculated to be 108° and 47° at 0 Kᵢ respectively. Provided that a contact angle smaller than 90° indicates the ability of the liquid to fully wet the substrate, the calculation shows that Sn will readily wet and spread across the surface of LLZTO during melt-quenching. While the contact angle of Cu is slightly higher than 90° at 0 K, it is widely reported that the contact angle may decrease considerably along with increasing temperature (Russell, Kenneth C., et al. “Theoretical and experimental studies of ceramic: metal wetting.” MRS bulletin 16.4 (1991): 46-52), making the contact angle of Cu smaller than 90° during the melt-quenching process Ab initio molecular dynamics simulation was therefore carried out on Cu and CuₓSn_{y} to study the wetting behavior at finite temperature, and the results are shown in FIG. 28(b). It can be observed that the Cu atoms tend to interact with the LLZTO surface and gradually form a coating layer over time. This process accelerates when Cu is mixed with Sn to form an alloy layer on the LLZTO, which is consistent with the experiment showing the Cu—Sn-based coating material (Cu/Sn=3) being superior to the Sn in terms of reducing the interfacial resistance (FIG. 21(f)). There are two major factors accounting for the better wetting of the Cu—Sn-based coating material (Cu/Sn=3): (i) the wetting kinetics is faster for Cu₃Sn than Cu as indicated by its higher mean squared displacement (FIG. 29(a)); (ii) Cu and Sn atoms are revealed to exhibit a strong synergetic effect when interacting with the LLZTO. The Sn atoms have a strong tendency to bind with Li when Cu₃Sn is coated on the surface of the LLZTO to reduce the Gibbs free energy of the interface between the Cu₃Sn and the LLZTO (FIG. 29(b)), resulting in the weakening of the original Li—O binding on the LLZTO surface. The oxygen atom has a very strong electron withdrawing ability and it originally attracts electrons from the lithium on the LLZTO surface. The weakening of the original Li—O binding leads to a less coordinated O, which will in turn withdraw electrons from Cu and strongly adsorb Cu atoms to the surface of the LLZTO, leading to a substantially better wetting of Cu₃Sn on the LLZTO surface.

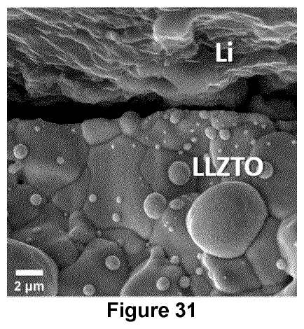

Similar to previously reported lithium alloying interlayers (Luo, Wei, et al. “Reducing interfacial resistance between garnet-structured solid-state electrolyte and Li-metal anode by a germanium layer.” Advanced Materials 29.22 (2017): 1606042; and Krauskopf, Thorben, et al. “Diffusion limitation of lithium metal and Li—Mg alloy anodes on LLZO type solid electrolytes as a function of temperature and pressure.” Advanced Energy Materials 9.44 (2019): 1902568), upon the contact of the LLZTO/Cu_{z}Sn_{y}Oₓ with the Li metal negative electrode in a battery, Cu_{z}Sn_{y}Oₓ coating undergoes a fast-alloying process with lithium to form a lithium rich, ternary system of Cu—Li—Sn interlayer at the interface of garnet and lithium metal. Such lithium rich ternary interlayer alloy (with minor Li₂O) fully eliminates the interfacial resistance, establishes an ultra-stable electrolyte-electrode interface, and provides a high lithium ion conduction through an alloying-dealloying process at the LLZTO/interlayer and Li/interlayer interfaces. In fact, LLZTO/Cu_{z}Sn_{y}Oₓ has the same lithium ion conductivity as pristine LLZTO (about 8×10⁻⁴ S cm⁻¹ at room temperature and 7×10⁻³ S cm⁻¹ at a temperature of 60° C.), reinforcing that Cu_{z}Sn_{y}Oₓ interlayer coating does not sacrifice the high ionic conductivity of garnet electrolytes. To corroborate the interfacial stability upon operation of the electrochemical cell, the interface after extensive lithium plating was characterized by SEM and EDS. A lithium symmetric cell was assembled using the Cu₃SnOₓ-coated LLZTO solid-state electrolyte, and the lithium electrode on one side of the solid-state electrolyte was allowed to be completely stripped and transported to the other side at a constant current density of 0.2 mA cm⁻² (FIG. 30). It was observed that no visible voids were formed in the vicinity of the newly formed interface between the plated Li and the Cu₃SnOₓ-coated LLZTO solid-state electrolyte as confirmed by SEM (FIGS. 28(c) and 28(d)), which is in stark contrast to the poor interfacial contact between Li and pristine LLZTO (FIG. 31). Despite an extensive plating of fresh lithium on the LLZTO, the Cu₃SnOₓ coating layer still remains substantially intact on the LLZTO surface according to the EDS mapping (FIG. 28(e)), while no significant dissolution of LLZTO into the lithium was found (FIGS. 28(f) to 28(h)), which reinforce the stability of LLZTO against lithium (Zhu, Yizhou, et al. “Origin of outstanding stability in the lithium solid electrolyte materials: insights from thermodynamic analyses based on first-principles calculations.” ACS applied materials & interfaces 7.42 (2015): 23685-23693).

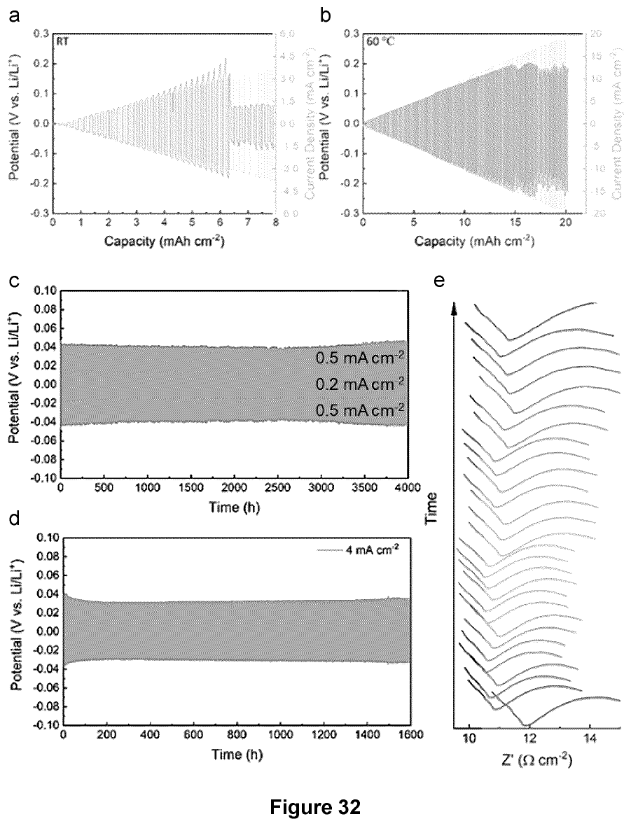

To evaluate the stability of Cu₃SnOₓ-coated LLZTO solid-state electrolytes coupled with lithium metal negative electrodes, symmetric cells were assembled and tested at different current densities and temperatures. The critical current density at which a significant dendrite growth and a short-circuit take place (Huang, Xiao, et al. “None-mother-powder method to prepare dense Li-garnet solid electrolytes with high critical current density.” ACS Applied Energy Materials 1.10 (2018): 5355-5365; and Song, Yongli, et al. “Revealing the short-circuiting mechanism of garnet-based solid-state electrolyte.” Advanced Energy Materials 9.21 (2019): 1900671) was tested for the Cu₃SnOₓ-coated LLZTO solid-state electrolyte. The assembled symmetric cell maintains its stability with increasing current densities until reaching a critical current density of about 3 mA cm⁻² (FIG. 32(a)) and about 15.2 mA cm⁻² (FIG. 32(b)) at room temperature and 60° C., respectively. Due to the complete elimination of interfacial resistance, the critical current density is solely affected by the ionic conductivity of the LLZTO. The ionic conductivity of the electrolyte increases 4 times more at 60° C. than that of at room temperature, while the critical current density also increases roughly 4 times. It is widely accepted that a critical current density of 3 mA cm⁻² is essential for the operation of practical lithium metal batteries with high energy positive electrodes (Flatscher, Florian, et al. “The natural critical current density limit for Li₇La₃Zr₂O₁₂ garnets.” Journal of Materials Chemistry A 8.31 (2020): 15782-15788); therefore, the all-solid-state lithium metal batteries based on Cu₃SnOₓ-coated LLZTO as defined herein possesses a critical current density that not only meets the requirement for practical applications but is also among the highest reported values for all kinds of solid electrolytes (Table 1).

TABLE 1
Comparison of electrochemical performances among different solid electrolytes.

| | | | | Critical | Critical | |
|---|---|---|---|---|---|---|
| | | | Stability | current | current | |
| | | Interfacial | symmetric | density | density | All-solid-state |
| | Interfacial | resistance | cell, RT | RT | 60° C. | full cell |
| Electrolyte | layer | (Ω cm⁻²) | (hours) | (mA cm⁻²) | (mA cm⁻²) | stability |
| Li_{6.5}La₃Zr_{1.5}Ta_{0.5}O₁₂ | Cu_{z}Sn_{y}Oₓ | 0 | 4000 | 3.0 | 15.2 | 94% after |
| | (6/5 < z/y < 3) | | | | | 1000 cycles |
| Li₇La_{2.75}Ca_{0.25}Zr_{1.75}Nb_{0.25}O₁₂ | Al | 75 | 42 | — | — | 91% after |
| | | | | | | 100 cycles |
| Li_{6.5}La₃Zr₂Ta_{0.5}O₁₂ | LiF | 345 | — | — | — | 85% after |
| | | | | | | 100 cycles |
| Li_{6.85}La_{2.9}Ca_{0.1}Zr_{1.75}Nb_{0.25}O₁₂ | Ge | 115 | 150 | — | — | — |
| Li_{6.5}La₃Zr₂Ta_{0.5}O₁₂ | C | 28 | 450 | — | — | — |
| Li_{6.5}La₃Zr₂Ta_{0.5}O₁₂ | PPC* | 14 | 1000 | 1.8 | — | >90% after |
| | | | | | | 300 cycles |
| Li₇La_{2.75}Ca_{0.25}Zr_{1.75}Nb_{0.25}O₁₂ | Al₂O₃ | 1 | 90 | — | — | >95% after |
| | | | | | | 50 cycles |
| Li_{6.4}La₃Zr₂Ta_{0.6}O₁₂ | LiTFSI/PEO | — | 700 | | 0.3 (90° | >90% after |
| | | | | | C.) | 200 cycles |
| Li_{5.9}Al_{0.2}La₃Zr_{1.75}W_{0.25}O₁₂ | C | 105 | 1000 | — | — | 80% after |
| | | | | | | 500 cycles |
| Li₇La_{2.75}Ca_{0.25}Zr_{1.75}Nb_{0.25}O₁₂ | Cu₆Sn₅ | 168 | 300 | — | — | 80% after |
| | | | | | | 100 cycles |
| Li₁₀Ge₁P₂S₁₂ | Li_{5.5}PS_{4.5}Cl_{1.5} | — | 1800 | | | 81% after |
| | | | | | | 2000 cycles |
| Al₂O₃/PEO/PVDF | — | — | 120 | — | — | 78% after |
| | | | | | | 400 cycles |
| Li₇La₃Zr₂O₁₂/PEO | — | 54 (60° | 1000 | — | — | 97% after |
| | | C.) | | | | 70 cycles |
| Sn—Li₆PS₅Cl | — | — | 700 | — | — | 89% after |
| | | | | | | 50 cycles |
| Li₆PS₅Cl | Ag/C | ~30 | — | — | — | 89% after |
| | | | | | | 1000 cycles |

*PPC: polypropylene carbonate.

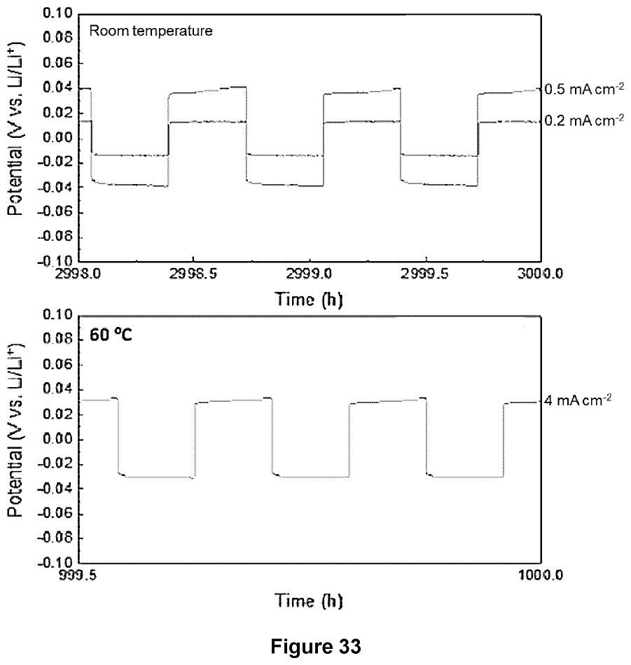

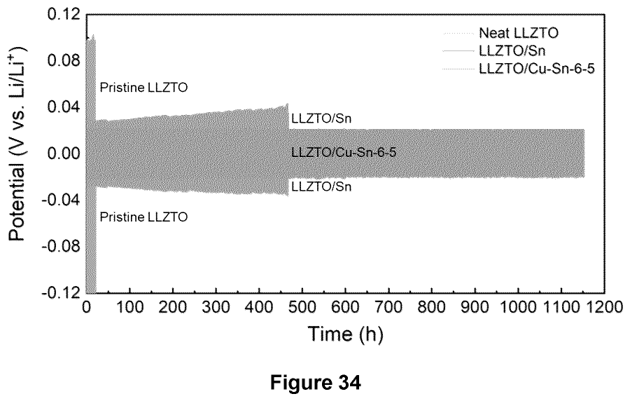

The cyclic stability of Li/LLZTO/Cu₃SnOₓ/Li at different current densities and temperatures was also tested, and the results are shown in FIGS. 32(c), 32(d) and 33. The symmetric cell consisting of Cu₃SnOₓ-coated LLZTO solid-state electrolyte with a Cu/Sn molar ratio of 3:1 (LLZTO/of Cu₃SnOₓ) can undergo lithium plating/stripping cycles at current densities of 0.2 mA cm⁻² and 0.5 mA cm⁻² for more than 4 000 hours at room temperature with negligible change of their overpotentials and no sign of an internal short-circuit, demonstrating the exceptional stability of Cu₃SnOₓ-coated LLZTO solid-state electrolyte in lithium metal batteries. The stable overpotential of Cu₃SnOₓ-coated LLZTO solid-state electrolyte is in stark contrast to the continuously increasing overpotentials of pristine LLZTO and Sn-coated LLZTO solid-state electrolytes (FIG. 34). Besides, the cyclic performance of Cu₃Sn₅Oₓ-coated LLZTO solid-state electrolyte was also tested, and the result is essentially identical to that of the Cu₃SnOₓ-coated LLZTO solid-state electrolyte, conforming to their similar EIS spectra where both show negligible interfacial resistance (FIG. 21(h)). The cyclic stability of symmetric cells based on Cu₃SnOₓ-coated LLZTO solid-state electrolyte was also evaluated at a temperature of 60° C., and under a high current density of 4 mA cm⁻², and operando EIS was further employed to characterize the change of impedance over time; the result shows that the symmetric cell can operate stably for 1 600 hours without an increase of overpotential (FIG. 32(d)). The Nyquist plot arising from the operando EIS measurement shows a nearly constant resistance of 11 Ωcm⁻² despite repeated Li plating/stripping cycles (FIG. 32(e)), which also conforms to the stable overpotential.

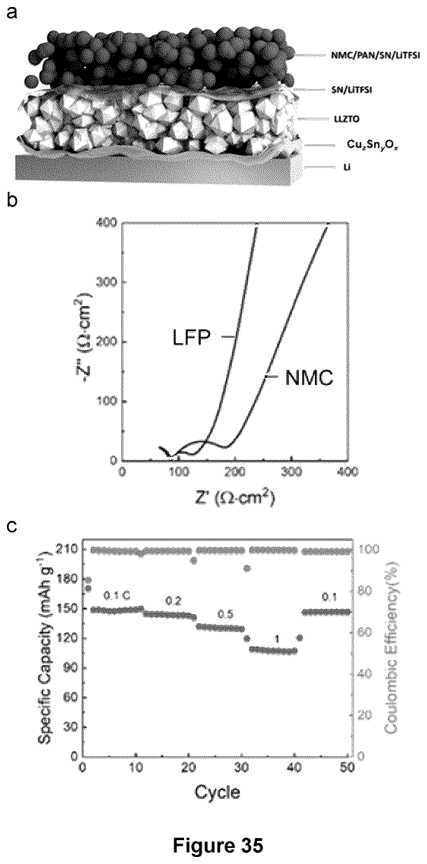

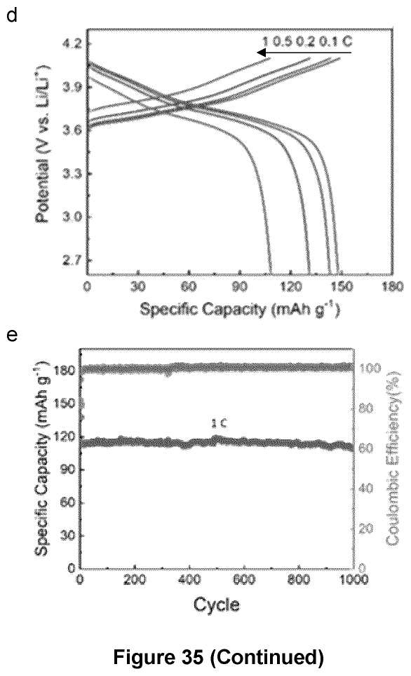

The results of symmetric cell tests indicate that the Cu₃SnOₓ-coated LLZTO solid-state electrolyte has a stable interface with lithium metal negative electrode, and the lithium metal battery consisting of the Cu₃SnOₓ-coated LLZTO solid-state electrolyte has the potential to possess excellent stability when coupled with high energy positive electrodes. To demonstrate the application of Cu₃SnOₓ-coated LLZTO solid-state electrolytes in practical batteries, all-solid-state lithium metal electrochemical cells were assembled using composite positive electrodes and lithium metal negative electrodes as schematically shown in FIG. 35(a). FIG. 35(b) displays the EIS spectra obtained at room temperature of the all-solid-state electrochemical cells consisting of LFP and NMC 811 positive electrodes. The semicircle at the high frequency region reflects the bulk ionic resistance arising from the Lit conduction in the LLZTO solid-state electrolyte, and the semicircle at the medium frequency region represents the charge transfer resistance of the positive electrode (Kim, Sangryun, et al. “A complex hydride lithium superionic conductor for high-energy-density all-solid-state lithium metal batteries.” Nature communications 10.1 (2019): 1-9). It is obvious that there are no semicircles in the low frequency region for both LFP and NMC 811 electrochemical cells, indicating that the interfacial resistance has been substantially fully eliminated, which is consistent with the symmetric cell results (FIG. 21(g)).

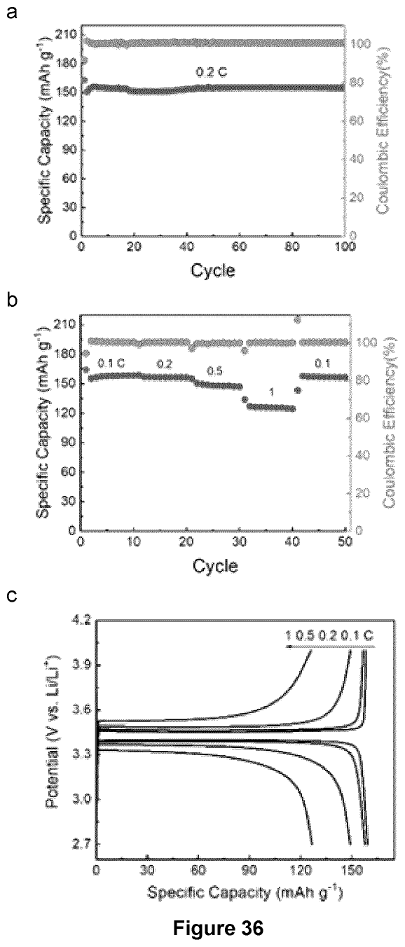

The cyclic and rate performance of the electrochemical cell with LFP positive electrodes were tested at room temperature, the result showed that the electrochemical cell can deliver a reversible capacity of 155 mAh g⁻¹ with a remarkable initial coulombic efficiency of 94.6% and exceptional capacity retention of 99% after 100 stable cycles at 0.2 C (FIG. 36(a)). Furthermore, the electrochemical cell can retain 80% of its capacity despite being cycled at a high rate of 1 C (FIG. 36(b)) with only slight increase of its charge/discharge overpotentials (FIG. 36(c)).

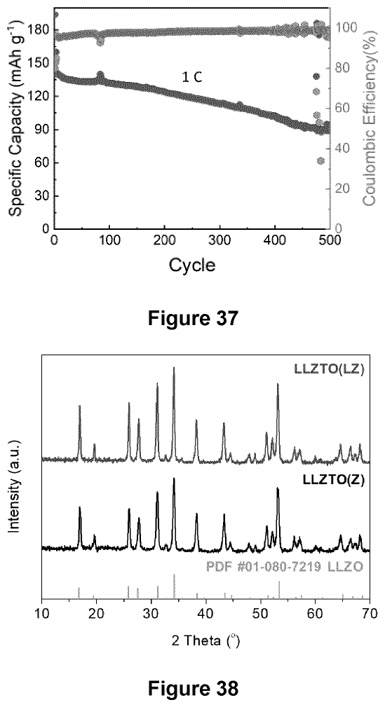

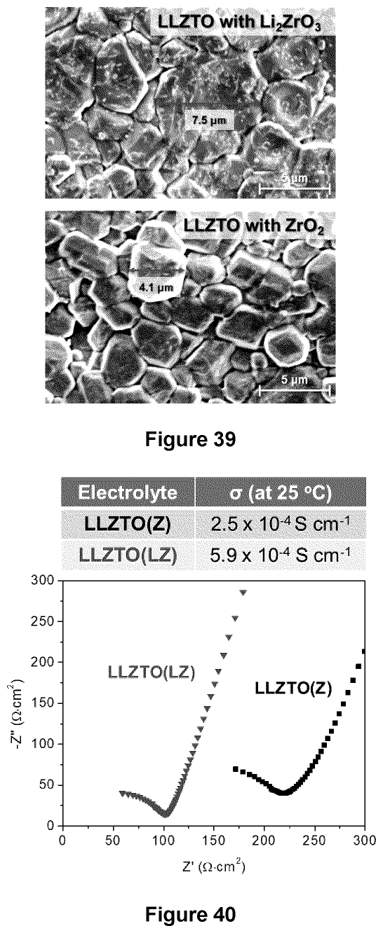

It is worth noting that a composite positive electrode comprising an active material and a polymer electrolyte is used for the electrochemical cell for two main reasons: (i) the polymer electrolyte in the composite positive electrode facilitates a better interfacial contact with the LLZTO solid-state electrolyte, leading to a better rate performance; (ii) the side reaction between the electrolyte and the positive electrode can be significantly prohibited especially for the electrochemical cell with a NMC 811 positive electrode that operates at a higher voltage. Due to the absence of side reactions at the positive electrode/electrolyte interface, the all-solid-state electrochemical cell with a high-voltage NMC 811 positive electrode possesses an excellent cyclic stability and initial coulombic efficiency. As shown in FIG. 36(c), the electrochemical cell shows an initial coulombic efficiency of 85.4%, and it can retain 74% of its capacity even when cycled at a high rate of 1 C. This excellent rate capability of the electrochemical cell is mostly ascribed to the resistance-free electrolyte/lithium interface and the stable lithium plating/stripping at the negative electrode with a low overpotential, which gives rise to the consistent voltage plateau of the electrochemical cell. The NMC 811 positive electrode is known for its poor cyclic stability due to the side reaction with the liquid electrolyte when operated at high voltage. Compared to the continuous capacity decay in the liquid cell (FIG. 37), the all-solid-state electrochemical cell can deliver 94% of its initial capacity after prolonged 1000 cycles at 1 C. More importantly, the 1000 stable cycles of the all-solid-state electrochemical cell have an average coulombic efficiency of above 99.9%, and no internal short-circuit arising from dendritic lithium growth was observed, indicating a superior safety as compared to the liquid cell. The electrochemical performances of the present electrochemical cells as defined herein are one of the best among all reported all-solid-state batteries (Table 1) thanks to the high interfacial stability at the interface of Cu₃SnOₓ-coated LLZTO solid-state electrolyte with the lithium metal negative electrode.

In summary, the surface of the garnet electrolyte is modified by coating a thin layer of Cu_{z}Sn_{y}Oₓ (6/5<z/y<1/2) to eliminate the interfacial resistance between the solid-state electrolyte and the lithium metal negative electrode. The mechanism of the coating was systematically studied, and the electrochemical performances of the surface modified garnet solid-state electrolyte were comprehensively tested in both symmetric and complete electrochemical cells. Four key findings can be summarized as follows:
(1) A uniform and dense coating of Cu_{z}Sn_{y}Oₓ on the surface of the garnet solid-state electrolyte can be achieved within seconds by means of the melt-quenching approach, and the surface modified garnet electrolyte shows negligible interfacial resistance when coupled with a lithium metal negative electrode. LLZTO/Cu_{z}Sn_{y}Oₓ has lithium ion conductivity of 8.0×10⁻⁴ and 7.0×10⁻³ S cm⁻¹ at room temperature and 60° C. with an electronic conductivity and lithium transference number of 7.0×10⁻⁸ S cm⁻¹ and 0.99, respectively.
(2) The synergistic effect between Cu and Sn when they interact with the garnet surface at high temperatures is revealed to be the major reason for forming a uniform coating, and the coating can be formed in a wide range of Cu—Sn compositions and temperatures.
(3) Symmetric cells based on the surface modified garnet electrolyte show a critical current density of 3 mA cm⁻² and 15.2 mA cm⁻² at room temperature and 60° C., respectively, and can operate substantially stably for 4000 hours with no short-circuiting.
(4) The all-solid-state electrochemical cell consisting of the surface modified garnet electrolyte and an NMC 811 positive electrode can deliver 94% of its initial capacity after prolonged 1000 cycles at 1 C with an average coulombic efficiency above 99.9%.

### Example 7—Synthesis and Characterization of Densified, Pristine Li_{6.5}La₃Zr_{1.5} Ta_{0.5}O₁₂ (LLZTO) Solid-State Electrolytes Obtained by a Fast Sintering Method

Pristine garnet-type solid-state electrolytes can be prepared by the rapid heating method as defined herein. As an example, Li_{6.5}La₃Zr_{1.5}Ta_{0.5}O₁₂ (LLZTO) was synthesized by a Joule heating method. In order to obtain a uniform, densified electrolyte, the conventional lithium metal hydroxide (LiOH) and lithium metal carbonate precursors (Li₂CO₃), which are usually used in traditional solid-state synthesis of oxide-based solid-state electrolytes, were replaced with lithium oxide precursors (Li₂O). LiOH and Li₂CO₃ can release gaseous products during heat treatments which results in pulverization of the final solid-state electrolyte and thus prevent its densification; the gaseous products from decomposition of LiOH and Li₂CO₃ precursors can also corrode the heating element (e.g. graphite) during Joule heating. In addition, the conventional zirconium dioxide precursor (ZrO₂) was also replaced with lithium zirconium oxide (Li₂ZrO₃) precursor. Li₂ZrOs precursor has a much lower melting point (720° C.) compared to ZrO₂ (2715° C.), meaning that it requires substantially lower sintering temperature and time. The respective precursors Li₂O, ZrO₂ or Li₂ZrO₃, La₂O₃, and Ta₂O₅ were weighted to obtain the desired stoichiometry. For example, LLZTO(Z) was prepared with Li₂O, ZrO₂, La₂O₃ and Ta₂O₅ precursors with a molar ratio of 3.57:1.5:1.5:0.25. In another example, LLZTO(LZ) was prepared with Li₂O, LiZrO₂, La₂O₃ and Ta₂O₅ precursors with a molar ratio of 2.75:1.5:1.5:0.25. The samples were then mixed uniformly via planetary ball milling at 300 rpm for about 10 hours. The resulting mixture was then cold pressed into pellets. The as-prepared precursor pellets were then sandwiched in between two graphite heating elements and subjected to a rapid heat treatment at a temperature of about 1200° C. for about 10 seconds under an argon atmosphere. The densified LLZTO(Z) and LLZTO(LZ) solid-state electrolytes were then removed from the rapid heating device and stored inside an argon-filled glove box.

As confirmed by the XRD data presented in FIG. 38, both LLZTO(Z) and LLZTO(LZ) solid-state electrolytes show substantially high purity phases with no sign of any impurity. The SEM images of LLZTO(Z) and LLZTO(LZ) solid-state electrolytes show that LLZTO(LZ) has larger grain sizes (about 7.5 μm) compared to the grain sizes of LLZTO(Z) (about 4.1 μm); the larger grain size for LLZTO(LZ) is apparently due to lower sintering temperature of LiZrO₂ used for the synthesis of LLZTO(LZ) compared to ZrO₂ used for the synthesis of LLZTO(Z) electrolyte. The EIS measurements of LLZTO(LZ) and LLZTO(Z) solid-state electrolytes show a Lit conductivity of 5.9×10⁻⁴ S cm⁻¹ and 2.5×10⁻⁴ S cm⁻¹, respectively. The higher Lit conductivity for LLZTO(LZ) is due to the larger grain size and thus lower population of grain boundaries, which can be translated to lower grain boundary resistance and higher Li⁺ conductivity.

A one-step synthesis process using the Joule heating system to synthesize garnet-type solid-sate electrolytes from metal oxide precursors was developed. This technique had substantially reduced the fabricating cost (i.e., time and energy) compared to conventional synthesis that uses a furnace to synthesize and sinter garnet-type solid-state electrolytes.

### Example 8—Synthesis and Characterization of Densified Li_{6.5}La₃Zr_{1.5} Ta_{0.5}O₁₂ (LLZTO) Solid-State Electrolytes Coated with a Layer of a Metal/Metal Fluoride Composite Material

The densified, pristine LLZTO(LZ) solid-state electrolyte prepared in Example 7 was coated with a layer of metal-based material comprising at least one metallic element selected from the groups 14 and 15 elements and at least one metal fluoride with the metal element selected from the groups 14 and 15 elements. For example, the metallic element selected from the groups 14 and 15 elements can react with lithium to form a Li-conductive compound, and the metal fluoride can react with lithium metal to form lithium fluoride (LiF) and a Li-conductive compound. LiF is an electronic insulator and upon its formation, it can act as a filler within the coating later and facilitate the Lit conduction and prevent the dissolution of metallic elements into the lithium metal negative electrode during cycling.

As an example, a mixture of Sn metal powder and SnF₂ precursors corresponding to the weight ratio of 10:0.5, 10:1, 10:2, 10:3, 10:4, 10:5 (Sn:SnF₂) were prepared by weighting the corresponding powders and uniformly mixing the powders using either a mortar and pestle or a ball milling method. The coating was applied on the surface of LLZTO(LZ) pellet prepared in Example 7. To coat a metal-based material on LLZTO(LZ) surface via the melt-quenching method, the LLZTO(LZ) pellet was rubbed over an excess amount of coating precursor powder spread on a weighting paper, during which the metal particles and metal fluoride particles attach to the garnet surface via Van der Waals forces. Then, the free powders were blown off from the garnet surface using a jet of argon gas. The metal-based precursor treated LLZTO(LZ) pellet was then sandwiched in between two graphite heating elements with the coated side facing upwards, and the temperature was rapidly increased to about 1100° C., and was maintained at this temperature for about 3 seconds to melt down the metal precursor and allow the liquid metal to fully spread across the LLZTO(LZ) surface. A uniform metal-based coating was obtained by rapidly quenching the sample at a cooling rate of about 1×10³° C. min⁻¹.

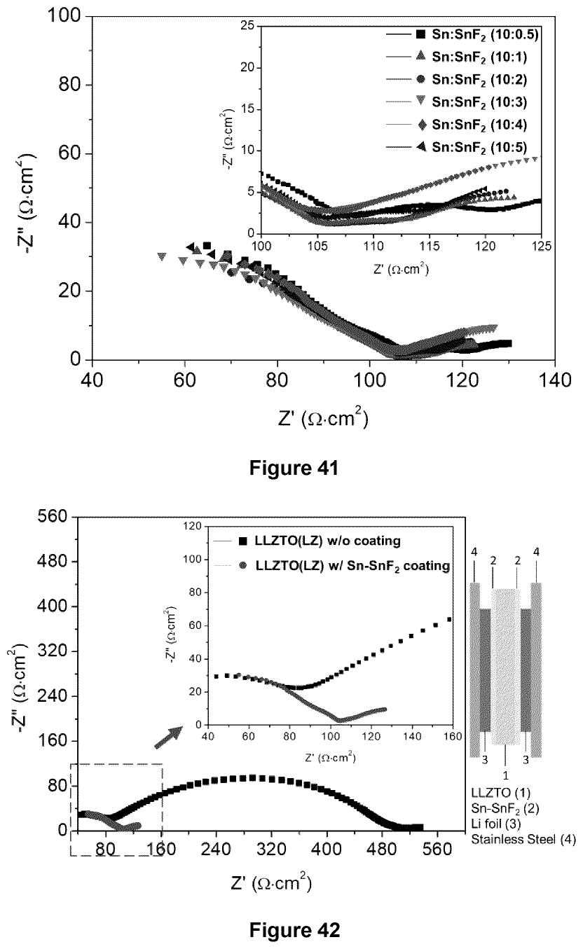

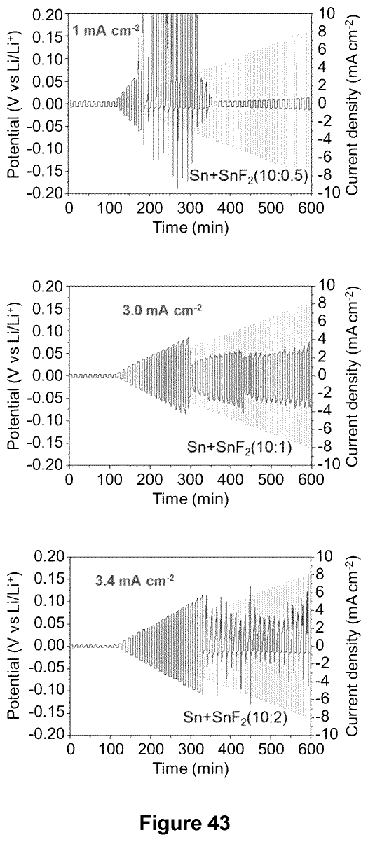

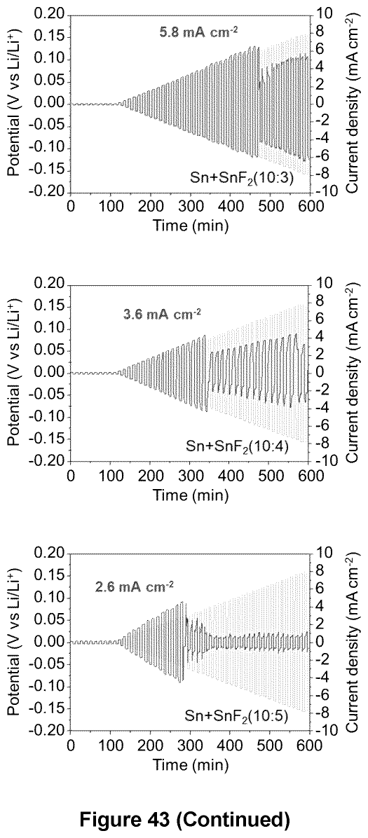

The interfacial resistance of different Sn—SnF₂-coated LLZTO(LZ) solid-state electrolytes prepared in Example 8 were characterized by EIS measurements. The results in FIG. 41 show that the interfacial resistance decreases from Sn:SnF₂ 10:0.5 (15.6Ω) to Sn:SnF₂ 10:3 (<1Ω) and then increases to 13.1Ω in Sn:SnF₂ 10:5, indicating that coating layers with composition Sn:SnF₂ 10:3 has the lowest interfacial resistance with lithium metal negative electrode. The critical current density at which a significant dendrite growth and a short-circuit takes place was tested for the Li/Sn—SnF₂-LLZTO(LZ)—Sn—SnF₂/Li with different Sn:SnF₂ ratios. The best rate performance with a critical current density of 5.8 mA cm⁻² was observed with the interlayer based on Sn:SnF₂ (10:3) (FIG. 42); whereas the LLZTO(LZ) solid-state electrolytes coated with Sn:SnF₂ (10:0.5), Sn:SnF₂ (10:1), Sn:SnF₂ (10:2), Sn:SnF₂ (10:4), Sn:SnF₂ (10:5) show a critical current density of 1.0, 3.0, 3.4, 3.6, and 2.6 mA cm⁻², respectively.

Numerous modifications could be made to any of the embodiments described above without distancing from the scope of the present invention. Any references, patents or scientific literature documents referred to in the present application are incorporated herein by reference in their entirety for all purposes.

What is claimed is:

1. A process for producing a coated solid-state electrolyte comprising a metal-based coating layer deposited on at least a portion of a surface of a solid-state electrolyte, the process comprising the steps of:
(i) depositing a precursor powder of a metal-based coating material on at least a portion of a surface of a solid-state electrolyte;
(ii) subjecting the precursor powder of the metal-based coating material to a rapid heating method to produce a melted metal-based coating material; and
(iii) solidifying the melted metal-based coating material to produce the coated solid-state electrolyte.

2. The process of claim 1, wherein step (i) is carried out by a mechanical or a chemical coating process, preferably by a powder deposition technique, and more preferably by a powder spreading technique a powder rubbing technique, or a powder dipping technique.

3-4. (canceled)

5. The process of claim 1, further comprising at least one of the following steps:
a step of removing an excess amount of the precursor powder of the metal-based coating material prior to step (ii),
a step of preparing the solid-state electrolyte; and
a step of densifying the solid-state electrolyte preferably carried out by a rapid heating method preferably selected from a Joule heating method, a microwave radiation method, a spark plasma sintering method, an induction heating method, a laser sintering method, an infrared radiation method, and an electric pulse consolidation method, and more preferably the rapid heath method is the Joule heating method.

6. The process of claim 1, wherein the rapid heating method is selected from a Joule heating method, a microwave radiation method, a spark plasma sintering method, an induction heating method, a laser sintering method, an infrared radiation method, and an electric pulse consolidation method, and preferably the rapid heating method is the Joule heating method.

7. (canceled)

8. The process of claim 1, wherein the rapid heating method is carried out:
for a period of less than about 90 s, or less than about 80 s, or less than about 70 s, or less than about 60 s, or less than about 50 s, or less than about 40 s, or less than about 30 s, or less than about 25 s, or less than about 20 s, or less than about 15 s, or less than about 10 s; or
for a period in the range of from about 1 s to about 90 s, or from about 1 s to about 80 s, or from about 1 s to about 70 s, or from about 1 s to about 60 s, or from about 1 s to about 50 s, or from about 1 s to about 40 s, or from about 1 s to about 30 s, or from about 1 s to about 25 s, or from about 1 s to about 20 s, or from about 1 s to about 15 s, or from about 1 s to about 10 s, or from about 2 s to about 10 s, or from about 3 s to about 10 s; or
at a temperature in e range of from about 550° C. to about 1400° C., or from about 600° C. to about 1350° C., or from about 650° C. to about 1300° C., or from about 700° C. to about 1250° C., or from about 700° C. to about 1200° C.; or
at a heating temperature ramp rate in the range of from about 5×10²° C. min⁻¹ to about 1.44×10⁻⁴° C. min⁻¹, and preferably at a beating temperature ramp rate of about 3×10³° C. min⁻¹.

9-12. (canceled)

13. The process of claim 1, wherein step (iii) is carried out at a cooling temperature ramp rate in the range of from about 5×10²° C. min⁻¹ to about 4.8×10³° C. min⁻¹, and preferably at a cooling temperature rate of about 3×10³° C. min⁻¹.

14-19. (canceled)

20. A coated solid-state electrolyte obtained by the process as defined in claim 1.

21. The coated solid-state electrolyte of claim 20, wherein the metal-based coating layer is uniformly deposited on the surface of the solid-state electrolyte or is heterogeneously dispersed on the surface of the solid-state electrolyte.

22. (canceled)

23. The coated solid-state electrolyte of claim 20, wherein the metal-based coating material is selected from the group consisting of a metallic element, a metal alloy, a metal oxide, a fluorinated metal, and a combination of at least two thereof.

24. The coated solid-state electrolyte of claim 23, wherein the metal-based coating material is a metallic element preferably selected from the group consisting of Al, Cu, Ag, Sn, Sb, and Bi, and more preferably metallic element is Cu, Ag or Sn.

25-26. (canceled)

27. The coated solid-state electrolyte of claim 23, wherein the metal-based coating material is a metal alloy, preferably wherein the metal alloy is a binary a ternary, or quaternary metal alloy.

28. (canceled)

29. The coated solid-state electrolyte of claim 27, wherein the metal alloy comprises a first metallic component selected from the metal elements of groups 14 and 15 of the periodic table of the elements and a second metallic component, wherein the second metallic component is different from the first metallic component, preferably wherein:
the first metallic component is selected from Sn, Sb, and Bi; or
the second metallic component is a alkali metal, an alkali earth metal, a transition metal, a post-transition metal, a metalloid, or a lanthanide, and more preferably the second metallic component is selected from the group consisting of Al, Mn, Co, Ni, Co, Ag, Sn, Sb, La, Tb, and Bi.

30-32. (canceled)

33. The coated solid-state electrolyte of claim 27, wherein the metal alloy is a Sn—Mn, Sn—Co, Sn—Ni, Sn—Cu, Sn—Cu—Tb, Sn—Ag, Sn—La, Sn—Bi—Ag, Sb—Cu, Sb—Ag, or Bi—Ag-based alloy, preferably wherein:
the metal alloy is Cu₃Sn or Cu₆Sn₅; or
the metal alloy is AgSnₓBi₁₋ₓ, where x is 0≤x≤1, and the metal-based coating is preferably selected from the group consisting of AgSn, AgSn_{0.8}Bi_{0.2}, AgSn_{0.8}Bi_{0.4}, AgSn_{0.4}Bi_{0.6}, and AgBi.

34-36. (canceled)

37. The coated solid-state electrolyte of claim 23, wherein the metal-based coating material is a fluorinated metal preferably selected from the group consisting of SnF₂, SnF₄, ZnF₂, InF₃, GaF₃, SbF₃, TlF, PbF₂, CuF₂, BiF₃, AlF₃, AgF, and LiF.

38. (canceled)

39. The coated solid-state electrolyte of claim 23, wherein the metal-based coating material is a metal oxide preferably selected from the group consisting of SnO, SnO₂, CuO, Cu₂O, Bi₂O₃, Al₂O₃, and Ag₂O.

40. (canceled)

41. The coated solid-state electrolyte of claim 20, wherein the solid-state electrolyte is a ceramic solid-state electrolyte, preferably a garnet-type solid-state electrolyte preferably selected from the group consisting of Li₇La₃Zr₂O₁₂ (LLZO) Li_{6.25}Al_{0.25}La₃Zr₂O₁₂ (Al-LLZO), Li_{6.5}La₃Zr_{1.5}Ta_{0.5}O₁₂ (LLZTO), Li_{6.35}Al_{0.05}La₃Zr₂Ta_{0.5}O₁₂ (Al-LLZTO), Li_{6.25}Nd₃Zr_{1.5}Ta_{0.5}O₁₂ (LNZTO), Li_{6.25}Sm₃Zr_{1.5}Ta_{0.5}O₁₂ (LSZTO), and Li_{6.25}(Sm_{0.5}La_{0.5})₃Zr_{1.5}Ta_{0.5}O₁₂ (LSZTO), and more preferably selected from the group consisting of Li₇La₃Zr₂O₁₂ (LLZO), Li_{6.25}Al_{0.25}La₃Zr₂O₁₂ (Al-LLZO), Li_{6.5}La₃Zr_{1.5}Ta_{0.5}O₁₂ (LLZTO), and Li_{6.35}Al_{0.05}La₃Zr₂Ta_{0.5}O₁₂ (Al-LLZTO).

42-44. (canceled)

45. The coated solid-state electrolyte of claim 20, further comprising:
at least one additional component preferably selected from the group consisting of iconic conductors, inorganic particles, glass or ceramic particles, nanoceramics, salts and other similar additives, wherein the additional component is dispersed within the electrolyte material or is in a separate layer, or
a second coating material deposited on at least a portion of an opposite surface of the solid-state electrolyte, preferably wherein the second coating material is a succinonitrile-based coating material preferably comprising a lithium salt.

46-51. (canceled)

52. An electrochemical cell comprising a negative electrode, a positive electrode and a coated solid-state electrolyte as defined in claim 20.

53. The electrochemical cell of claim 52, wherein the metal-based coating layer of the coated solid-state electrolyte faces the negative electrode and, if present the second coating material of the coated solid-state electrolyte faces the positive electrode.

54. (canceled)

55. The electrochemical cell of claim 52, wherein:
the negative electrode comprises an electrochemically active material comprising an alkali metal, an alkaline earth metal, an alloy comprising at least one alkali or alkaline earth metal, a non-alkali and non-alkaline earth metal, or an alloy or an intermetallic compound, and preferably the electrochemically active material of the negative electrode comprises lithium metal or an alloy thereof, or
the positive electrode comprises an electrochemically active material preferably selected from the group consisting of metal oxides, lithium metal oxides, metal phosphates, lithium metal phosphates, titanates, lithium titanates, metal fluorophosphates, lithium metal fluorophosphates, metal oxyfluorophosphates, lithium metal oxyfluorophosphates, metal sulfates, lithium metal sulfates, metal halides (e.g. fluorides), lithium metal halides (e.g. fluorides), sulfur, lithium sulfur, selenium, lithium selenium and a combination of at least two thereof, preferably wherein the metal of the electrochemically active material is selected from the group consisting of titanium (Ti), iron (Fe), magnesium (Mg), manganese (Mn), vanadium (V), nickel (Ni), cobalt (Co), aluminum (Al), zirconium (Zr), niobium (Nb), and a combination of at least two thereof.

56-59. (canceled)

60. The electrochemical cell of claim 52, wherein the positive electrode comprises:
at least one electronically conductive material preferably selected from the group consisting of carbon black, acetylene black, graphite, graphene, carbon fibers, carbon nanofibers, carbon nanotubes and a combination of at least two thereof; or
at least one binder preferably selected from the group consisting of a polymeric binder of polyether type, a fluorinated polymer, and a water-soluble; or
at least one additional component preferably selected from the group consisting of ionic conductors, inorganic particles, glass or ceramic particles nanoceramics, salts and other similar additives.

61-65. (canceled)

66. A battery comprising at least one electrochemical cell as defined in claim 52, wherein said battery is preferably selected from the group consisting of a lithium battery, a lithium-ion battery, a sodium batter, a sodium-ion battery, a potassium battery, a potassium-ion battery, a magnesium battery, and a magnesium-ion battery, and more preferably said battery is a lithium battery or a lithium-ion battery.

67-68. (canceled)
